(19) United States
(12) Patent Application Publication
(10) Pub. No.: US 2026/0143268 A1
(43) Pub. Date: May 21, 2026

(54) ELECTRONIC DEVICE COMPRISING ACOUSTIC CONDUIT

(71) Applicant: Samsung Electronics Co., Ltd., Suwon-si (KR)

(72) Inventors: Myoungdae JIN, Suwon-si (KR); Soohyun SEO, Suwon-si (KR); Wonho LEE, Suwon-si (KR); Seokmin JANG, Suwon-si (KR); Sujeong CHO, Suwon-si (KR); Hun HEO, Suwon-si (KR); Hyunju HONG, Suwon-si (KR)

(21) Appl. No.: 19/442,316

(22) Filed: Jan. 7, 2026

Related U.S. Application Data
(63) Continuation of application No. PCT/KR2024/006715, filed on May 17, 2024.

(30) Foreign Application Priority Data
Jul. 13, 2023 (KR) 10-2023-0091405
Sep. 1, 2023 (KR) 10-2023-0116510

(51) Int. Cl. H04R 1/02

(52) U.S. Cl. CPC H04R 1/025; H04R 1/028; H04R 2201/02; H04R 2499/15

(57) ABSTRACT

An electronic device is provided. The electronic device includes a frame including a first frame part and a second frame part which is coupled to the first frame part and includes an audio hole, a display including a first portion supported by the first frame part and a second portion which extends from the first portion in a first direction and is covered by the second frame part, a speaker arranged on the frame, and an acoustic conduit which connects the space in front of the speaker and the audio hole, penetrates at least a portion of the frame, and is separated, by at least a portion of the first frame part, from the space in which the second portion is positioned.

### CROSS-REFERENCE TO RELATED APPLICATION(S)

This application is a continuation application, claiming priority under 35 U.S.C. § 365(c), of an International application No. PCT/KR2024/006715, filed on May 17, 2024, which is based on and claims the benefit of a Korean patent application number 10-2023-0091405, filed on Jul. 13, 2023, in the Korean Intellectual Property Office, and of a Korean patent application number 10-2023-0116510, filed on Sep. 1, 2023, in the Ministry of Intellectual Property, the disclosure of each of which is incorporated by reference herein in its entirety.

### BACKGROUND

### 1. Field

The disclosure relates to an electronic device comprising an acoustic duct.

### 2. Description of Related Art

An electronic device may include a speaker for providing an audio signal and a display for providing visual information. Sound waves generated from the speaker may be transmitted to an audio hole along an acoustic duct inside the electronic device. In order to connect the speaker and the audio hole inside the electronic device, a portion of the acoustic duct may be formed as an empty space inside the electronic device. The display may be electrically connected to an electronic component (e.g., display driver integrated circuitry and/or a printed circuit board) for driving the display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device comprising an acoustic duct.

Additional aspects will be set forth in part in the description which follows and, in part, will be apparent from the description, or may be learned by practice of the presented embodiments.

In accordance with an aspect of the disclosure, an electronic device is provided. The electronic device includes a frame including a first frame part, and a second frame part, coupled to the first frame part, including an audio hole, a display including a first portion contacted with a display panel including a plurality of pixels, a second portion, opposite to the first portion, connected to display driver integrated circuitry configured to control the display panel, and a third portion, connecting the first portion and the second portion, protruding from the first portion toward a first direction, covered by the second frame part, a speaker disposed in the frame, and an acoustic duct passing through at least a portion of the frame to connect a space in a front of the speaker inside the frame and the audio hole, wherein the acoustic duct is separated from a space in which the third portion is positioned by at least a portion of the first frame part.

In accordance with another aspect of the disclosure, an electronic device is provided. The electronic device includes a housing including a first housing part, and a second housing part, movably coupled with respect to the first housing part in a first direction and a second direction opposite to the first direction, the second housing defining an audio hole, a flexible display including a first portion, a second portion, opposite to the first portion of the display, electrically connected to display driver integrated circuitry configured to control the display, and a third portion, extending from the first portion of the display to the second portion of the display, at least partially curved, wherein the third portion of the display is covered by the second housing part, a speaker disposed in the second housing part, wherein the second housing part defines an acoustic duct for connecting a space in front of the speaker and the audio hole, and a plate disposed between a portion of the second housing part defining the acoustic duct and the display to separate the acoustic duct and a space in which the third portion of the display is positioned.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a top plan view of an electronic device in a first state according to an embodiment of the disclosure;

FIG. 2B is a bottom view of an electronic device in a first state according to an embodiment of the disclosure;

FIG. 2C is a top plan view of an electronic device in a second state according to an embodiment of the disclosure;

FIG. 2D is a bottom view of an electronic device in a second state according to an embodiment of the disclosure;

FIGS. 3A and 3B are exploded perspective views of an electronic device according to various embodiments of the disclosure;

FIG. 4A is a cross-sectional view of an electronic device in a first state according to an embodiment of the disclosure;

FIG. 4B is a cross-sectional view of an electronic device in a second state according to an embodiment of the disclosure;

FIG. 5A illustrates a configuration in which a second frame part is coupled to a first frame part according to an embodiment of the disclosure;

FIG. 5B illustrates an electronic device according to an embodiment of the disclosure;

FIG. 5C is a cross-sectional view of an electronic device cut along line C-C′ of FIG. 5B, according to an embodiment of the disclosure;

FIG. 5D illustrates a portion of an electronic device in which a display module is disposed according to an embodiment of the disclosure;

FIG. 6A is a cross-sectional view of an electronic device cut along line D-D′ of FIG. 5B according to an embodiment of the disclosure;

FIG. 6B is a perspective view of a portion of a first frame part according to an embodiment of the disclosure;

FIG. 6C is a front view of a first surface of a first frame part according to an embodiment of the disclosure;

FIG. 7A is a cross-sectional view of an electronic device cut along line D-D′ of FIG. 5B according to an embodiment of the disclosure;

FIG. 7B illustrates a frame in which a sealing member is disposed according to an embodiment of the disclosure;

FIG. 8 is a cross-sectional view of an electronic device cut along line D-D′ of FIG. 5B according to an embodiment of the disclosure;

FIG. 9 is a cross-sectional view of an electronic device cut along line D-D′ of FIG. 5B according to an embodiment of the disclosure;

FIG. 10 illustrates a frame from which a display is omitted according to an embodiment of the disclosure; and

FIG. 11 is a graph for comparing a quality of an audio signal provided by an electronic device according to a comparative example and an audio signal provided by an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

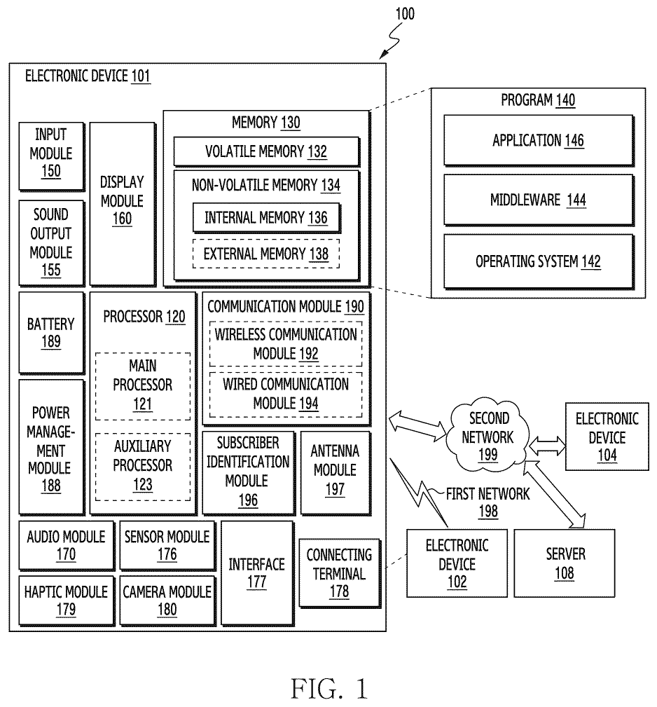

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

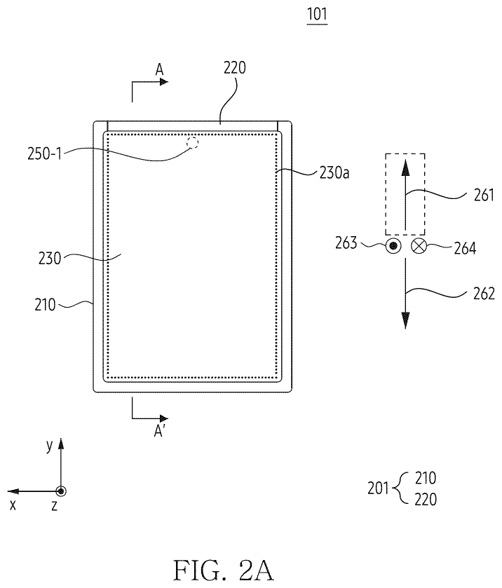

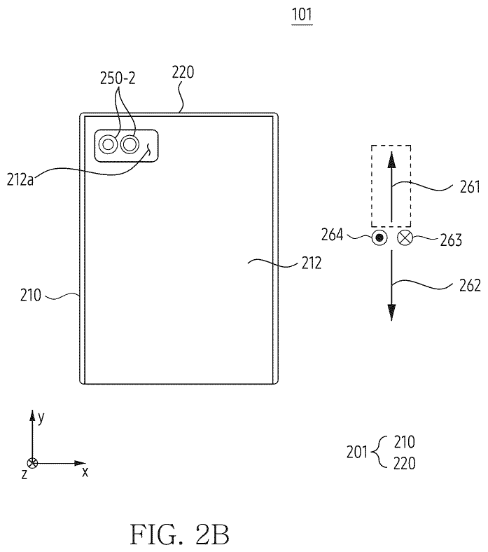

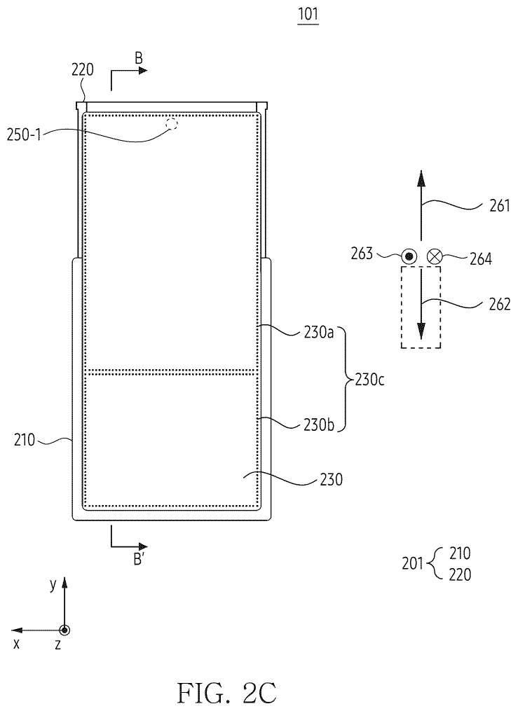

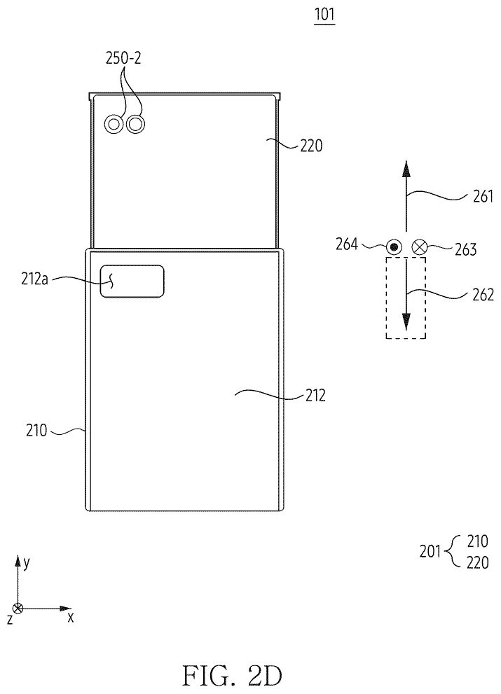

According to an embodiment of the disclosure, a display of the display module 160 may be flexible. For example, the display may include a display area exposed outside a housing (e.g., a housing 201 of FIG. 2A) of the electronic device 101 providing at least a portion of an external surface of the electronic device 101. Since the display has flexibility, at least a portion of the display may be rollable into the housing or slidable into the housing. A size of the display area may be changed according to a size of the at least a portion of the display rolled into the housing or slid into the housing. The electronic device 101 including the display may be in a plurality of states including a first state providing the display area having a first size and a second state providing the display area having a second size different from the first size. The first state may be exemplified through descriptions of FIGS. 2A and 2B.

FIG. 2A is a top plan view of an electronic device in a first state according to an embodiment of the disclosure.

Referring to FIG. 2A, an electronic device 101 may include a housing 201 and a display 230. For example, the housing 201 may include a first housing part 210 and a second housing part 220. The second housing part 220 may be movable with respect to the first housing part 210 in a first direction 261 parallel to ay-axis or a second direction 262 parallel to the y-axis and opposite to the first direction 261.

In the disclosure, it is described that the second housing part 220 is moved with respect to the first housing part 210, but the disclosure is not limited thereto. The housing 201 may have a structure in which an overall size of the housing 201 may be changed according to a change in a relative positional relationship between the first housing part 210 and the second housing part 220. By an operation of a motor 361 to be described later, the relative positional relationship between the first housing part 210 and the second housing part 220 may be changed. For example, by the motor 361, the first housing part 210 or the second housing part 220 may be movable, and both the first housing part 210 and the second housing part 220 may be movable.

The electronic device 101 may be in the first state. In the first state, the second housing part 220 may be movable with respect to the first housing part 210 in the first direction 261 of the first direction 261 and the second direction 262. In the first state, the second housing part 220 may not be movable in the second direction 262 with respect to the first housing part 210.

In the first state, the display 230 may provide the display area having the smallest size. For example, in the first state, the display area may correspond to an area 230a. Although not illustrated in FIG. 2A, in the first state, an area (e.g., an area 230b of FIG. 2C) of the display 230 different from the area 230a, which is the display area, may be included in the first housing part 210. For example, in the first state, the area (e.g., the area 230b of FIG. 2C) may be covered by the first housing part 210. For example, in the first state, the area may be rollable into the first housing part 210. For example, in the first state, the area 230a may include a planar portion. However, it is not limited thereto. For example, in the first state, the area 230a may include a curved portion extending from the planar portion and positioned in an edge portion. The area 230a may be referred to as a first portion (or a portion) of the display 230, and the area 230b may be referred to as a second portion (or another portion) of the display 230.

The first state may be referred to as a slide-in state or a closed state in that at least a portion of the second housing part 220 is positioned in the first housing part 210. The first state may be referred to as a reduced state in terms of providing the display area having the smallest size. However, it is not limited thereto.

For example, the second housing part 220 may include a first image sensor 250-1 in the camera module 180 exposed through a portion of the area 230a and facing a third direction 263 parallel to a z-axis. Although not illustrated in FIG. 2A, the second housing part 220 may include one or more second image sensors in the camera module 180 exposed through a portion of the second housing part 220 and facing a fourth direction 264 parallel to the z-axis and opposite to the third direction 263. The one or more second image sensors may be exemplified through a description of FIG. 2B.

FIG. 2B is a bottom view of an electronic device in a first state according to an embodiment of the disclosure.

Referring to FIG. 2B, in the first state, one or more second image sensors 250-2 disposed in the second housing part 220 may be positioned in a structure disposed in the first housing part 210 for the one or more second image sensors 250-2. Light from the outside of the electronic device 101 may be received to the one or more second image sensors 250-2 through the structure in the first state. Since the one or more second image sensors 250-2 are positioned in the structure in the first state, the one or more second image sensors 250-2 may be exposed through the structure in the first state. The structure may be implemented in various ways. For example, the structure may be an opening or a notch. For example, the structure may be an opening 212a in a first plate 212 of the first housing part 210 surrounding at least a portion of the second housing part 220. However, it is not limited to this. For example, in the first state, the one or more second image sensors 250-2 included in the second housing part 220 may be covered by the first plate 212 of the first housing part 210.

The first state may be changed to the second state. For example, the first state (or the second state) may be changed to the second state (or the first state) through intermediate states between the first state and the second state.

The first state (or the second state) may be changed to the second state (or the first state) based on a user input. For example, the first state (or the second state) may be changed to the second state (or the first state) in response to the user input to a physical button exposed through a portion of the first housing part 210 or a portion of the second housing part 220. For example, the first state (or the second state) may be changed to the second state (or the first state) in response to a touch input to an executable object displayed in the display area. For example, the first state (or the second state) may be changed to the second state (or the first state) in response to the touch input having a contact point on the display area and having a pressing intensity greater than or equal to a reference intensity. For example, the first state (or the second state) may be changed to the second state (or the first state) in response to a voice input received through a microphone of the electronic device 101. For example, the first state (or the second state) may be changed to the second state (or the first state) in response to an external force applied to the first housing part 210 and/or the second housing part 220 to move the second housing part 220 with respect to the first housing part 210. For example, the first state (or the second state) may be changed to the second state (or the first state) in response to a user input identified from an external electronic device (e.g., earbuds or a smart watch) connected to the electronic device 101. However, it is not limited thereto.

The second state may be exemplified through descriptions of FIGS. 2C and 2D.

FIG. 2C is a top plan view of an electronic device in a second state according to an embodiment of the disclosure.

Referring to FIG. 2C, the electronic device 101 may be in the second state. In the second state, the second housing part 220 may be movable with respect to the first housing part 210 in the second direction 262 of the first direction 261 and the second direction 262. In the second state, the second housing part 220 may not be movable in the first direction 261 with respect to the first housing part 210.

In the second state, the display 230 may provide the display area having the largest size. In the second state, the display area may correspond to an area 230c including the area 230a and the area 230b. The area 230b included in the first housing part 210 in the first state may be exposed in the second state. In the second state, the area 230a may include a planar portion. However, it is not limited thereto. The area 230a may include a curved portion extending from the planar portion and positioned in an edge portion. In the second state, unlike the area 230a in the first state, the area 230b may include a planar portion of the planar portion and a curved portion. However, it is not limited thereto. The area 230b may also include the curved portion extending from the planar portion of the area 230b and positioned in an edge portion.

The second state may be referred to as a slide-out state or an open state in terms of extending at least a portion of the second housing part 220 disposed in the outside of the first housing part 210 with respect to the first state. The second state may be referred to as an extended state in terms of providing the display area having the largest size. However, it is not limited thereto.

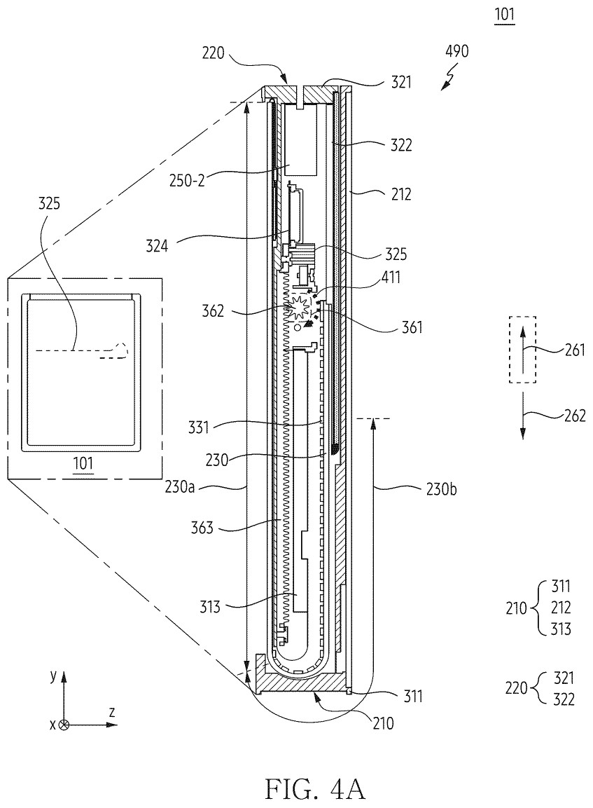

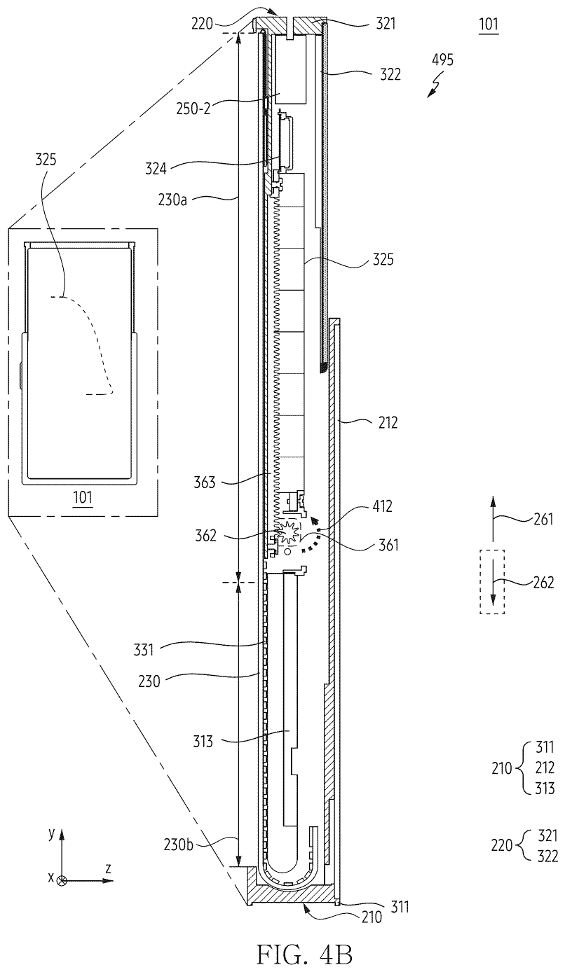

When a state of the electronic device 101 is changed from the first state to the second state, the first image sensor 250-1 facing the third direction 263 may move together with the area 230a according to a movement of the second housing part 220 in the first direction 261. Although not illustrated in FIG. 2C, the one or more second image sensors 250-2 facing the fourth direction 264 may be moved according to the movement of the second housing part 220 in the first direction 261 when the state of the electronic device 101 is changed from the first state to the second state. A relative positional relationship between the one or more second image sensors 250-2 and the structure exemplified through a description of FIG. 4B may be changed according to the movement of the one or more second image sensors 250-2. The change in the relative positional relationship may be exemplified through FIG. 2D.

FIG. 2D is a bottom view of an electronic device in a second state according to an embodiment of the disclosure.

Referring to FIG. 2D, in the second state, the one or more second image sensors 250-2 may be positioned outside the structure. For example, the structure may include the opening 212a. In the second state, the one or more second image sensors 250-2 may be positioned outside the opening 212a in the first plate 212. The one or more second image sensors 250-2 may be exposed through the opening 212a in the first state. Since the one or more second image sensors 250-2 are positioned outside the first housing part 210 in the second state, the one or more second image sensors 250-2 may be exposed in the second state. Since the one or more second image sensors 250-2 are positioned outside the structure in the second state, the relative positional relationship in the second state may be different from the relative positional relationship in the first state.

In a case that the electronic device 101 does not include the structure, such as the opening 212a, the one or more second image sensors 250-2 may be exposed in the second state of the first state and the second state.

Although not illustrated in FIGS. 2A, 2B, 2C, and 2D, the electronic device 101 may be in an intermediate state between the first state and the second state. For example, a size of the display area in the intermediate state may be larger than a size of the display area in the first state and smaller than a size of the display area in the second state. The display area in the intermediate state may correspond to an area including the area 230a and a portion of the area 230b. In the intermediate state, a portion of the area 230b is exposed, and another portion (or a remaining portion) of the area 230b may be covered by the first housing part 210 or may be rollable into the first housing part 210. However, it is not limited thereto.

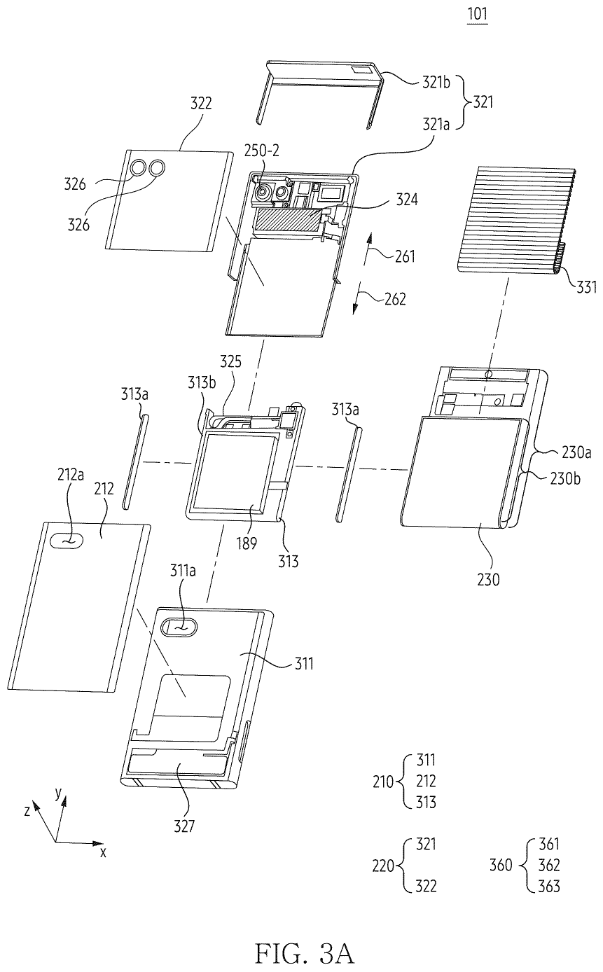

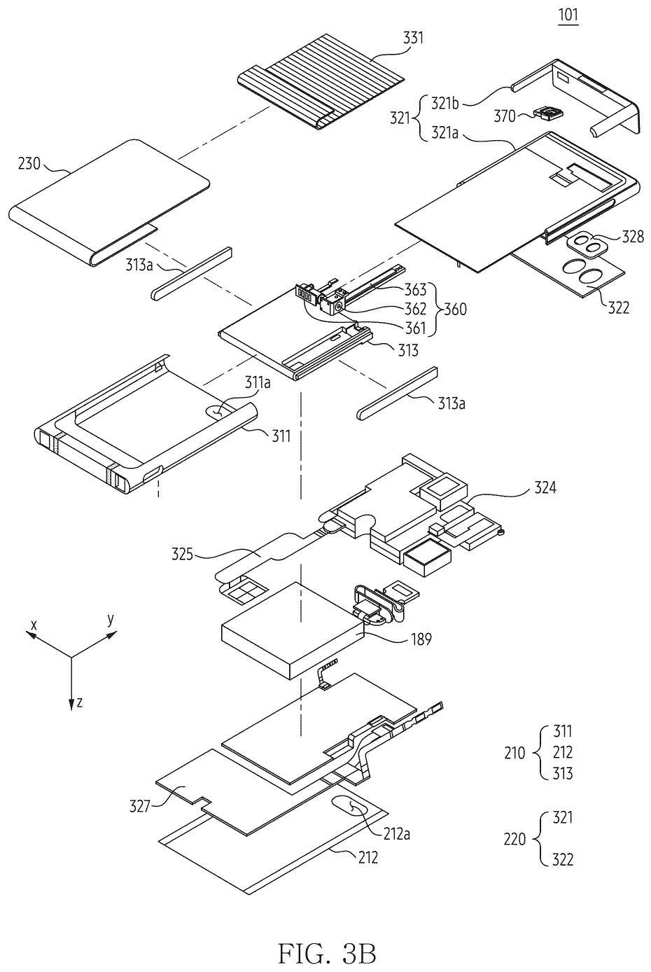

Referring back to FIG. 1, the electronic device 101 may include structures for moving the second housing (e.g., the second housing part 220 of FIG. 2A) of the electronic device 101 with respect to the first housing (e.g., the first housing part 210 of FIG. 2A) of the electronic device 101. The structures may be exemplified through descriptions of FIGS. 3A and 3B.

FIGS. 3A and 3B are exploded perspective views of an electronic device according to various embodiments of the disclosure.

Referring to FIGS. 3A and 3B, an electronic device 101 may include a first housing part 210, a second housing part 220, a display 230, and a driving unit 360.

According to an embodiment of the disclosure, the first housing part 210 may include a first cover 311, a first plate 212, and a frame 313.

For example, the first cover 311 may at least partially form a side portion of an outer surface of the electronic device 101. The first cover 311 may include an opening 311a for one or more second image sensors 250-2. The first cover 311 may include a surface supporting the first plate 212. The first cover 311 may be coupled to the first plate 212. The first cover 311 may include the frame 313. The first cover 311 may be coupled to the frame 313.

For example, the first plate 212 may at least partially form a rear portion of the outer surface. The first plate 212 may include an opening 212a for the one or more second image sensors 250-2. The first plate 212 may be disposed on the surface of the first cover 311. The opening 212a may be aligned with the opening 311a.

For example, the frame 313 may be at least partially surrounded by the first cover 311.

For example, the frame 313 may be at least partially surrounded by the display 230. The frame 313 may be at least partially surrounded by the display 230, but a position of the frame 313 may be maintained independently of a movement of the display 230. The frame 313 may be arranged in relation to at least a portion of components of the display 230. The frame 313 may include rails 313a providing (or guiding) a path for a movement of at least one component of the display 230.

For example, the frame 313 may be coupled to at least one component of the electronic device 101. The frame 313 may support a battery 189. The battery 189 may be supported through a recess or a hole in a surface 313b of the frame 313. On a surface on the frame 313, the frame 313 may be coupled to an end of a flexible printed circuit board (FPCB) 325. Although not explicitly illustrated in FIGS. 3A and 3B, another end of the FPCB 325 may be connected to a printed circuit board 324 through at least one connector. The printed circuit board 324 may be electrically connected to another printed circuit board 327 through the FPCB 325.

For example, the frame 313 may be coupled to at least one structure of the electronic device 101 for a plurality of states including the first state and the second state. The frame 313 may fasten a motor 361 of the driving unit 360.

According to an embodiment of the disclosure, the second housing part 220 may include a second cover 321 and a second plate 322.

For example, the second cover 321 may be at least partially surrounded by the display 230. Unlike the frame 313, the second cover 321 may be coupled to at least a portion of an area 230a of the display 230 surrounding the second cover 321 so that the display 230 is moved along the second housing part 220 that is moved with respect to the first housing part 210. For example, the second cover 321 may include a first frame part 321a and a second frame part 321b. The first frame part 321a and the second frame part 321b will be described later.

For example, the second cover 321 may be coupled to at least one component of the electronic device 101. The second cover 321 may be coupled to the printed circuit board 324 including components of the electronic device 101. For example, a processor (e.g., the processor 120 of FIG. 1) may be disposed on the printed circuit board 324. The second cover 321 may support the one or more second image sensors 250-2.

For example, the second cover 321 may be coupled to at least one structure of the electronic device 101 for the plurality of states including the first state and the second state. The second cover 321 may fix a rack gear 363 of the driving unit 360.

For example, the second cover 321 may be coupled to the second plate 322.

For example, the second plate 322 may be coupled to the second cover 321 to protect the at least one component of the electronic device 101 coupled in the second cover 321 and/or the at least one structure of the electronic device 101 coupled in the second cover 321. The second plate 322 may include a structure for the at least one component. The second plate 322 may include one or more openings 326 for the one or more second image sensors 250-2. The one or more openings 326 may be aligned with the one or more second image sensors 250-2 disposed on the second cover 321. A size of each of the one or more openings 326 may correspond to a size of each of the one or more second image sensors 250-2. A camera deco member 328 may be disposed between the second cover 321 and the second plate 322. The second cover 321 may support a speaker 370.

For example, the electronic device 101 may include a support member 331 for supporting at least a portion of the display 230. For example, the support member 331 may include a plurality of bars (of multi-bar). The plurality of bars may be coupled to each other. The support member 331 may support an area 230b of the display 230.

According to an embodiment of the disclosure, the driving unit 360 may include the motor 361, a pinion gear 362, and the rack gear 363.

For example, the motor 361 may operate based on power from the battery 189. For example, the power may be provided to the motor 361 in response to the user input.

For example, the pinion gear 362 may be coupled to the motor 361 through a shaft. The pinion gear 362 may be rotated based on the operation of the motor 361 transmitted through the shaft.

For example, the rack gear 363 may be arranged in relation to the pinion gear 362. For example, teeth of the rack gear 363 may be engaged with teeth of the pinion gear 362. The rack gear 363 may be moved in a first direction 261 or a second direction 262 according to the rotation of the pinion gear 362. The second housing part 220 may be moved in the first direction 261 and the second direction 262 by the rack gear 363 that is moved according to the rotation of the pinion gear 362 due to the operation of the motor 361. The first state of the electronic device 101 may be changed to a state (e.g., the one or more intermediate states or the second state) different from the first state through the movement of the second housing part 220 in the first direction 261. The second state of the electronic device 101 may be changed to a state (e.g., the one or more intermediate states or the first state) different from the second state through the movement of the second housing part 220 in the second direction 262. A change of the first state to the second state by the driving unit 360 and a change of the second state to the first state by the driving unit 360 may be exemplified through FIGS. 4A and 4B.

FIG. 4A is a cross-sectional view of an electronic device in a first state according to an embodiment of the disclosure. FIG. 4B is a cross-sectional view of an electronic device in a second state according to an embodiment of the disclosure.

For example, FIG. 4A is a cross-sectional view of an electronic device 101 according to an embodiment of the disclosure, cut along line A-A′ of FIG. 2A. For example, FIG. 4B is a cross-sectional view of the electronic device 101 according to an embodiment of the disclosure, cut along line B-B′ of FIG. 2C.

Referring to FIGS. 4A and 4B, a motor 361 may be operated based at least in part on the defined user input received in a state 490, which is the first state. A pinion gear 362 may be rotated in a first rotation direction 411 based at least in part on the operation of the motor 361. A rack gear 363 may be moved in a first direction 261, based at least in part on the rotation of the pinion gear 362 in the first rotation direction 411. Since a second cover 321 in a second housing part 220 fixes the rack gear 363, the second housing part 220 may be moved in the first direction 261 based at least in part on the movement of the rack gear 363 in the first direction 261. Since the second cover 321 in the second housing part 220 is coupled to at least a portion of an area 230a of a display 230 and fixes the rack gear 363, the display 230 may be moved based at least in part on the movement of the rack gear 363 in the first direction 261. The display 230 may be moved along rails 313a. A shape of at least a portion of the plurality of bars of a support member 331 of the display 230 may be changed when the state 490 is changed to a state 495, which is the second state.

For example, an area 230b of the display 230 may be moved according to the movement of the display 230. The area 230b may me moved through a space between a first cover 311 and a frame 313 when the state 490 is changed to the state 495 according to the defined user input. Unlike the area 230b rolled into the space in the state 490, the area 230b in the state 495 may be exposed.

For example, since the second cover 321 in the second housing part 220 is coupled to a printed circuit board 324 connected to the other end of a FPCB 325 and fixes the rack gear 363, a shape of the FPCB 325 may be changed when the state 490 is changed to the state 495.

The motor 361 may be operated based at least in part on the defined user input received in the state 495. The pinion gear 362 may be rotated in a second rotation direction 412 based at least in part on the operation of the motor 361. The rack gear 363 may be moved in a second direction 262, based at least in part on the rotation of the pinion gear 362 in the second rotation direction 412. Since the second cover 321 in the second housing part 220 fixes the rack gear 363, the second housing part 220 may be moved in the second direction 262 based at least in part on the movement of the rack gear 363 in the second direction 262. Since the second cover 321 in the second housing part 220 is coupled to the at least a portion of the area 230a of the display 230 and fixes the rack gear 363, the display 230 may be moved based at least in part on the movement of the rack gear 363 in the second direction 262. The display 230 may be moved along the rails 313a. The shape of at least a portion of the plurality of bars of the support member 331 of the display 230 may be changed when the state 495 is changed to the state 490. The support member 331 may be moved with respect to the first housing part 210. The support member 331 accommodated inside the first housing part 210 in the state 490 may be positioned between the first cover 311 and the frame 313. According to a movement of the support member 331, the display 230 may be moved with respect to the first housing part 210.

For example, the area 230b of the display 230 may be moved according to the movement of the display 230. The area 230b may move through the space between the first cover 311 and the frame 313 when the state 495 is changed to the state 490 according to the defined user input. Unlike the area 230b exposed in the state 495, the area 230b in the state 490 may be rolled into the space.

For example, since the second cover 321 in the second housing part 220 is coupled to the printed circuit board 324 connected to the other end of the FPCB 325 and fixes the rack gear 363, the shape of the FPCB 325 may be changed when the state 495 is changed to the state 490.

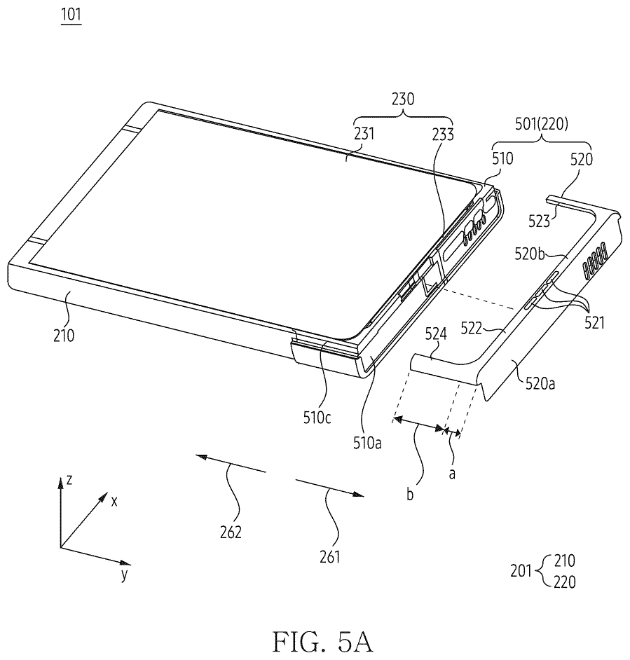

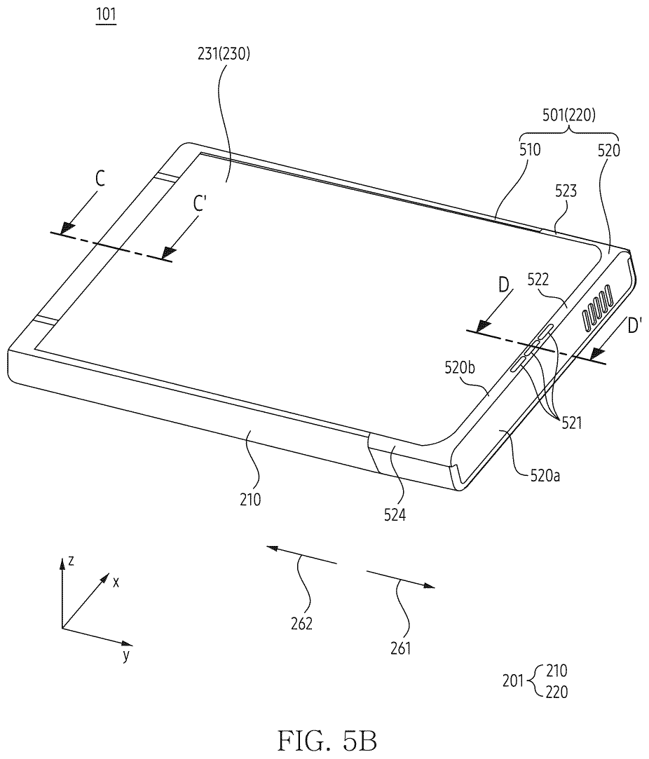

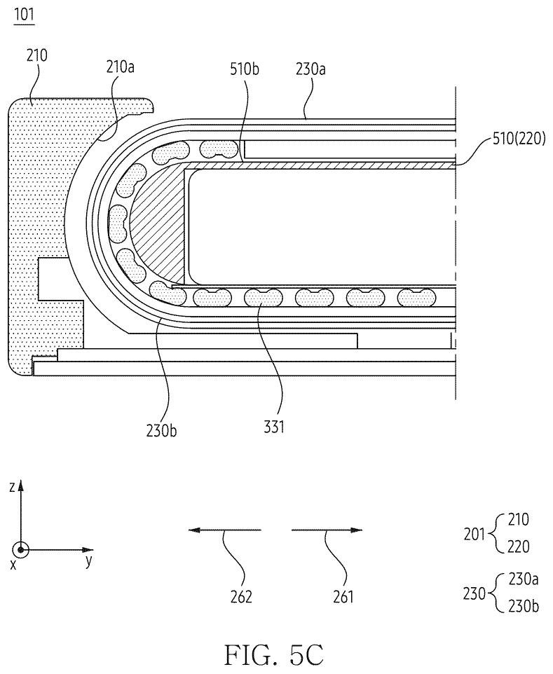

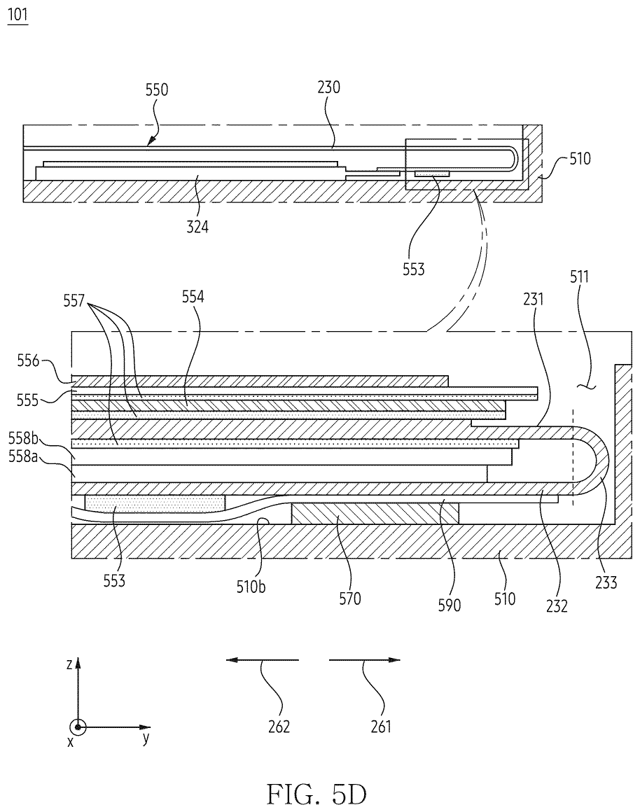

FIG. 5A illustrates a configuration in which a second frame part is coupled to a first frame part according to an embodiment of the disclosure. FIG. 5B illustrates an electronic device according to an embodiment of the disclosure. FIG. 5C is a cross-sectional view of an electronic device, cut along line C-C′ of FIG. 5B, according to an embodiment of the disclosure. FIG. 5D illustrates a portion of an electronic device in which a display module is disposed according to an embodiment of the disclosure.

Hereinafter, one or more components to be described later with reference to the drawings may be implemented together with components of the electronic device 101 described with reference to FIGS. 2A, 2B, 2C, 2D, 3A, 3B, 4A, and 4B. Descriptions overlapping the above-described descriptions may be omitted.

In the disclosure, a relative term, such as top, bottom, front, and rear may be used to describe a relative position between components. For example, in a case that the electronic device 101 illustrated in the drawings is flipped, top and bottom may be switched. For example, in a case that the electronic device 101 illustrated in the drawings is flipped, front and rear may be switched.

Referring to FIGS. 5A and 5B, according to an embodiment of the disclosure, the electronic device 101 may include a housing 201 and a display 230. The housing 201 may be referred to as the housing 201 described with reference to FIGS. 2A to 2D, 3A, 3B, 4A, and 4B. For example, the housing 201 may include a first housing part (e.g., the first housing part 210 of FIG. 2A) and a second housing part (e.g., the second housing part 220 of FIG. 2A) movable with respect to the first housing part 210. As described above, according to an embodiment of the disclosure, the electronic device 101 may include the first housing part 210 and the second housing part 220 that are movably coupled, but the disclosure is not limited thereto. For example, the electronic device 101 may be a bar-type electronic device that forms a single housing in which the first housing part 210 and the second housing part 220 are integrally coupled.

According to an embodiment of the disclosure, the electronic device 101 may include a frame 501 including a first frame part 510 and a second frame part 520. For example, the frame 501 may be referred to as the second cover 321 illustrated in FIG. 3A. For example, the first frame part 510 may be referred to as the first frame part 321a illustrated in FIG. 3A. For example, the second frame part 520 may be referred to as the second frame part 321b illustrated in FIG. 3A.

According to an embodiment of the disclosure, the first frame part 510 may support at least a portion of the display 230. The first frame part 510 may include a first surface 510a and a second surface (e.g., a second surface 510b of FIG. 5C). The first surface 510a may be a surface of the first frame part 510 facing a first direction 261. The second surface 510b may be perpendicular to the first surface 510a and may be a surface of the first frame part 510 and supporting at least a portion of the display 230. For example, the second surface 510b may be referred to as a surface of the first frame part 510 facing a +z direction. The second frame part 520 may cover a portion of the first surface 510a and the second surface 510b.

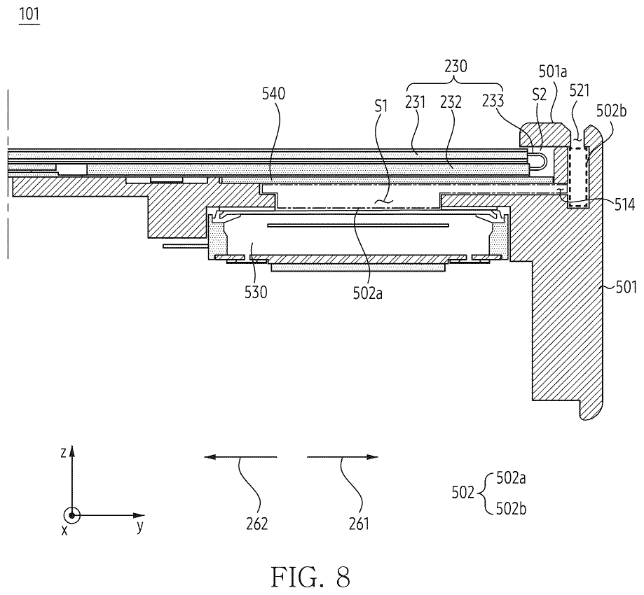

In FIG. 5A, the first frame part 510 and the second frame part 520 are illustrated as a separate structure, but the disclosure is not limited thereto. For example, the first frame part 510 and the second frame part 520 may be integrally formed (refer to FIG. 8). A case that the first frame part 510 and the second frame part 520 are integrally formed may have a relatively better exterior than a case that the first frame part 510 and the second frame part 520 are separately formed. In a case that the first frame part 510 and the second frame part 520 are integrally formed, it may be difficult to assemble the electronic device 101. For example, when assembling the electronic device 101, at least a portion of a support member (e.g., the support member 331 of FIG. 3A) may be coupled to rails (e.g., the rails 313a of FIG. 3A). A cover of the support member 331 may be required so that the support member 331 does not deviate from the rails 313a. In a case that the first frame part 510 and the second frame part 520 are integrally formed, assembly difficulty in relation to coupling of the display 230 may be increased, since the second housing part 220 should perform a function of covering the support member 331. In terms of lowering the assembly difficulty, it may be advantageous to configure the second frame part 520 separately from the first frame part 510. For example, the second frame part 520 may be coupled after being manufactured separately from the first frame part 510. For example, the second frame part 520 may be coupled to a side surface of the first frame part 510 and cover a portion of the first frame part 510.

The second frame part 520 may be referred to as a protective member, a deco member, and/or a cover member in terms of covering the portion of the first frame part 510. For example, a portion of the second frame part 520 may protect a third portion (e.g., the third portion 233 of FIG. 5D) to be described later by covering between the display 230 and the first frame part 510. For example, the second frame part 520 may include a non-conductive material. For example, the second frame part 520 may be manufactured through an injection process using a non-conductive material (e.g., resin). However, it is not limited thereto. According to examples, at least a portion of the second frame part 520 may include a conductive material. In addition, in order to reduce static electricity, a conductive tape (not illustrated) connected to an electrostatic discharge path may be disposed on at least a portion of a portion where the first frame part 510 and the second frame part 520 are coupled.

According to an embodiment of the disclosure, the second frame part 520 may include a first portion 520a for covering the first surface 510a facing the first direction 261 and a second portion 520b extending substantially perpendicular to the first portion 520a. The second portion 520b may include a flange portion 522 for covering the third portion 233 of the display 230 and protrusions 523 and 524 that may be coupled to a guide groove 510c formed on at least a portion of a side surface of the first frame part 510. For example, the second portion 520b may include the first protrusion 523 coupled to a portion of a side surface (e.g., a side surface facing a +x direction) of the first frame part 510 and a second protrusion 524 coupled to a portion of another side surface (e.g., a side surface facing a −x direction) of the first frame part 510. The flange portion 522 may be formed between the first protrusion 523 and the second protrusion 524. For example, a length a of the flange portion 522 may be shorter than a length b of the protrusions 523 and 524. Since the length a of the flange portion 522 is shorter than the length b of the protrusions 523 and 524, the flange portion 522 covering a second portion 232 may not overlap the display 230, or extent overlapping the display 230 may be reduced.

Referring to FIG. 5C, an area 230b (or a portion 230b) of the display may to be rollable into the first housing part 210 based on a movement of the second housing part 220. For example, the area 230b of the display may include a bendable portion that may be at least partially deformed according to the movement of the second housing part 220. For example, another portion of the display (e.g., the area 230a (or another portion 230a) of the display of FIG. 5D) may always be visible from the outside, independently of a state of the electronic device 101. For example, regardless of whether the electronic device 101 is in a first state (e.g., a slide-in state) or a second state (e.g., a slide-out state), the area 230a (or the other portion 230b) of the display may be a planar portion that is flat.

For example, in the first state, the area 230b of the display may be rollable into the first housing part 210. In the second state, the area 230b of the display may be at least partially unfolded. As the display 230 moves, a position of the area 230b of the display may be changed. For example, in the first state, the area 230b of the display may be positioned inside the first housing part 210. For example, in the second state, the area 230b of the display may be positioned at least partially outside the first housing part 210. When the area 230b of the display is positioned in an outer side the first housing part 210, a display area of the display 230 may be expanded as the area 230b of the display is unfolded. For example, the area 230b of the display may be referred to as the above-described area (e.g., the area 230b of FIG. 2C), and the other area 230a of the display may be referred to the above-described area (e.g., the area 230a of FIG. 2A).

According to an embodiment of the disclosure, the first frame part 510 may be movably coupled to the first housing part 210. When the first frame part 510 is moved in the first direction 261 from the first housing part 210, a movement of the display 230 coupled to the first frame part 510 in the first direction 261 may be caused. As the display 230 moves in the first direction 261, the area 230b of the display rolled into the first housing part 210 may be drawn out of the first housing part 210. For example, when the first frame part 510 moves in a second direction 262 facing the first housing part 210, the movement of the display 230 coupled to the first frame part 510 in the second direction 262 may be caused. As the display 230 moves in the second direction 262, the area 230b of the display extracted from the outside of the first housing part 210 may be rolled into the first housing part 210.

Referring to FIG. 5D, according to an embodiment of the disclosure, the electronic device 101 may include the display 230 and a display module 550 including a display driver integrated circuitry 553 (DDI) for controlling the display 230.

According to an embodiment of the disclosure, the display 230 may be disposed in a recess 511 formed in the first frame part 510. A size of the recess 511 may be larger than a size of the display 230 disposed in the recess 511. For example, the recess 511 may be formed as a portion of the second surface (510b of FIG. 5C) (e.g., the surface facing the +z direction) of the first frame part 510 is partially recessed to an internal side of the first frame part 510 (e.g., in a −z direction). For example, the display 230 disposed in the recess 511 may be coupled to the first frame part 510. For example, the electronic device 101 may include an adhesive tape 570 that adheres the display 230 to the first frame part 510.

According to an embodiment of the disclosure, the display 230 may include a first portion 231, the second portion 232, and the third portion 233. The first portion 231 may be contacted with a display panel including a plurality of pixels. The second portion 232 may be opposite to the first portion 231 and may be connected to the display driver integrated circuitry 553 configured to control the display panel. The third portion 233 may connect the first portion 231 and the second portion 232.

According to an embodiment of the disclosure, the first portion 231 may face a front of the electronic device 101 (e.g., in the +z direction). The second portion 232 may face the inside of the electronic device 101 (e.g., in the −z direction). The second portion 232 may be electrically connected to the display driver integrated circuitry 553. The third portion 233 may be curved to connect the first portion 231 and the second portion 232 disposed opposite to each other.

According to an embodiment of the disclosure, the plurality of pixels may be configured to emit light toward the front (e.g., in the +z direction). Since the display panel is exposed to the outside of the frame 501, a plurality of protective members for protecting the display panel may be disposed on the display panel. For example, a flexible glass 554, a protective layer 555, and/or a protective film 556 may be disposed on the display panel. The plurality of protective members may include adhesive layers 557 for fixing the flexible glass 554, the protective layer 555, and/or the protective film 556. The plurality of protective members may be formed of a substantially transparent material to transmit light emitted through the display panel.

For example, the second portion 232 may be disposed under the first portion 231 (e.g., in the −z direction). For example, when the first portion 231 is viewed from above, the second portion 232 may be overlapped (or be covered) by the first portion 231. The second portion 232 may be spaced apart from the first portion 231. For example, a spacer 558a and/or a reinforcing member 558b may be disposed between the first portion 231 and the second portion 232. For example, the spacer 558a may reduce inflow of moisture by occupying a portion of a space between the first portion 231 and the second portion 232. For example, the spacer 558a may reduce a curvature of the third portion 233 by occupying the space between the first portion 231 and the second portion 232. For example, the reinforcing member 558b may support the first portion 231. For example, the second portion 232 may be electrically connected to an electronic component for driving the display 230. For example, the display driver integrated circuitry 553 and the printed circuit board 324 may be electrically connected to the second portion 232. Since the display driver integrated circuitry 553 is connected to the second portion 232 disposed under the first portion 231, according to an embodiment of the disclosure, a structure of the display 230 may be referred to as a chip on plastic (COP) structure. For example, the printed circuit board 324 may be disposed between the second portion 232 and the first frame part 510. For example, the printed circuit board 324 and the display driver integrated circuitry 553 may be electrically connected through the second portion 232. For example, the display module 550 may include a protective tape 590 for protecting the display driver integrated circuitry 553. For example, the protective tape 590 may include a conductive material to discharge static electricity generated inside the frame 501 or static electricity introduced from outside the frame 501.

For example, the third portion 233 may extend (or protrude) from the first portion 231 in the first direction 261. For example, the third portion 233 may electrically connect the first portion 231 and the second portion 232 by extending from the first portion 231 to the second portion 232. The third portion 233 may be at least partially bent to connect the first portion 231 and the second portion 232. For example, the third portion 233 may have flexibility. For example, the third portion 233 may be a portion of a polymer substrate (e.g., a polyimide substrate) extending from the first portion 231 to the second portion 232, but is not limited thereto. For example, the third portion 233 may also be implemented as a flexible printed circuit board.

For example, the display driver integrated circuitry 553 may be configured to control an operation of the display 230. For example, the display driver integrated circuitry 553 may be configured to provide visual information through the display 230, based on receiving an image control signal and/or image data from a processor (e.g., the processor 120 of FIG. 1) disposed on the printed circuit board 324. The display driver integrated circuitry 553 may be electrically connected to the display 230 by being disposed on the third portion 233 of the display 230.

Referring back to FIG. 5C, according to an embodiment of the disclosure, the electronic device 101 may include a structure and a component for an operation of the deformable display 230. For example, the first housing part 210 may include a recess 210a to provide a space for at least a portion of the second housing part 220 and the area 230b of the display. For example, in the first state, the second housing part 220 and the area 230b of the display may be positioned in an internal space of the first housing part 210 formed by the recess 210a. For example, the electronic device 101 may include the support member 331 (e.g., a plurality of bars) for supporting the area 230b of a flexible display. As illustrated in FIG. 5D, since the first housing part 210 includes the structure and the component for the operation of the deformable display 230, a space for accommodating the third portion 233 may be insufficient in a case that the third portion (e.g., the third portion 233 of FIG. 5D) of the display 230 extends from the first portion (e.g., the first portion 231 of FIG. 5D) in the second direction 262. According to an embodiment of the disclosure, the third portion 233 may extend from the first portion 231 in the first direction 261. For example, the third portion 233 may be positioned close to a periphery of the first frame part 510 toward the first direction 261.

Referring back to FIGS. 5A and 5B, the third portion (e.g., the third portion 233 of FIG. 5A) may extend from the first portion 231 in the first direction 261. For example, the third portion 233 may extend from a periphery of the first portion 231 toward the first direction 261 to the second portion 232. Referring to FIG. 5A, a portion of the third portion 233 extending in the first direction 261 may be exposed to the outside of the first frame part 510. The second frame part 520 may be coupled to the first frame part 510 to cover the exposed third portion 233. Referring to FIG. 5B, in a state in which the second frame part 520 is coupled to the first frame part 510, the third portion 233 may be covered by the second frame part 520. The third portion 233 may be covered by the third portion 233 of the second frame part 520. The second frame part 520 may protect the third portion 233 by covering the third portion 233 exposed to the outside of the first frame part 510. Since the second frame part 520 maintains a state fixed to the first frame part 510 even when the first frame part 510 moves in the first direction 261 and the second direction 262, the third portion 233 may be covered by the second frame part 520 independently of a movement of the second housing part 220.

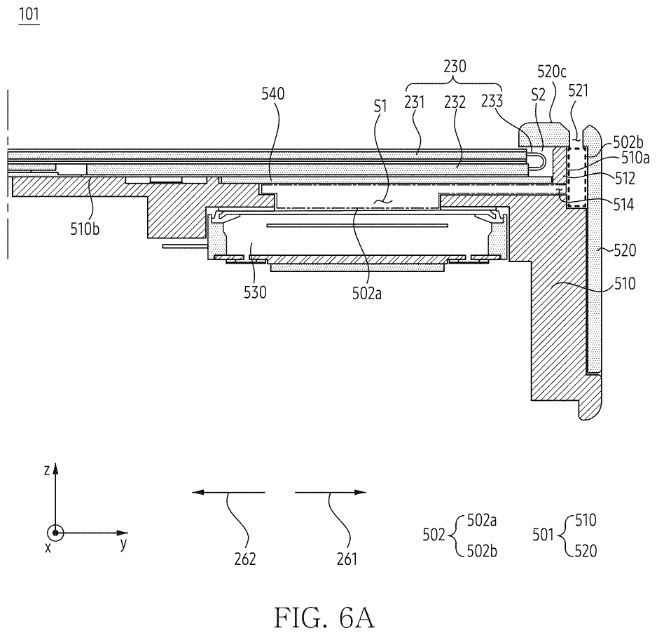

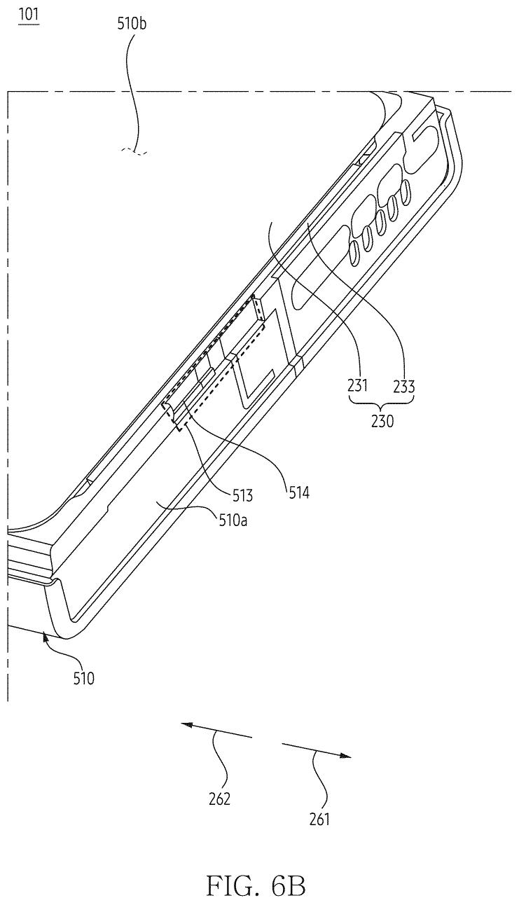

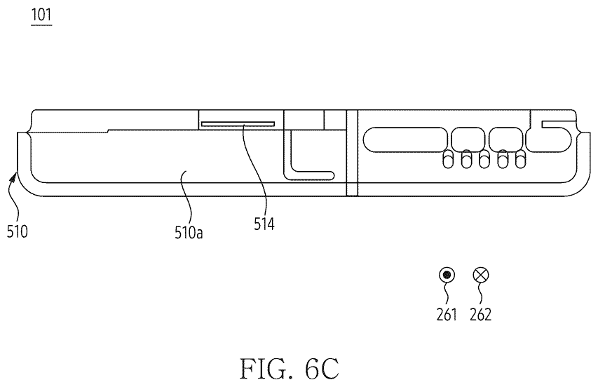

According to an embodiment of the disclosure, the electronic device 101 may include a speaker (e.g., a speaker 530 of FIG. 6A) configured to provide an audio signal. For example, the speaker 530 may be disposed inside the frame 501 (e.g., the first frame part 510). The speaker 530 may generate sound waves by vibrating based on a control signal provided from at least one processor (e.g., the processor 120 of FIG. 1). The frame 501 may include an acoustic duct (e.g., an acoustic duct 502 of FIG. 6A) to provide a path through which the sound waves generated from the speaker 530 are transmitted to the outside of the electronic device 101. The acoustic duct 502 may connect an internal space of the frame 501 in which the speaker 530 is disposed and an outer space of the frame 501.

According to an embodiment of the disclosure, the first frame part 510 may include a recessed portion (e.g., a recessed portion 513 of FIG. 6B) and a through hole (e.g., a through hole 514 of FIG. 6B) formed on the first surface 510a. For example, by forming a space between the second frame part 520 covering the first surface 510a and the first surface 510a, the recessed portion 513 may form a portion (e.g., a second duct of FIG. 6A) of the acoustic duct 502. For example, the through hole 514 may connect a portion (e.g., a first duct 502a of FIG. 6A) of the acoustic duct 502 formed inside the first frame part 510 and the recessed portion 513. A structure of the acoustic duct 502 will be described later through FIGS. 6B and 6C.

For example, the second frame part 520 may include an audio hole 521. For example, the audio hole 521 may be one or more. For example, the audio hole 521 may be connected to the acoustic duct 502 so that the sound waves transmitted through the acoustic duct 502 may be transmitted to the outside of the electronic device 101. For example, the audio hole 521 may be connected to the recessed portion 513 forming the portion of the acoustic duct 502. For example, the audio hole 521 may be formed in the flange portion 522 for covering the third portion 233. The sound waves generated from the speaker 530 may be transmitted to the outside of the electronic device 101 through the acoustic duct 502 and the audio hole 521.

As described above, since the third portion 233 extends from the first portion 231 in the first direction 261, a space in which the third portion 233 is positioned (e.g., a space S2 of FIG. 6A) and the acoustic duct 502 may at least partially overlap. For example, the space S2 in which the third portion 233 extending from the first portion 231 is positioned may be connected to the acoustic duct 502.

As the acoustic duct 502 and the space S2 in which the third portion 233 is positioned at least partially overlap, interference between the sound waves transmitted along the acoustic duct 502 and the third portion 233 may occur. When the sound waves generated from the speaker 530 are transmitted along the acoustic duct 502, the third portion 233 may affect the sound waves by vibrating by the sound waves. For example, as noise occurs by vibration of the third portion 233, a quality of the audio signal provided from the speaker 530 may be deteriorated. For example, the third portion 233 may be damaged by a foreign substance and/or air introduced through the acoustic duct 502. For example, in a case that high-pressure air is introduced into the acoustic duct 502, the third portion 233 may be damaged by the pressure of the air. For example, in a case that a rigid foreign substance is introduced into the acoustic duct 502, the third portion 233 may be damaged by the foreign substance.

According to an embodiment of the disclosure, the electronic device 101 may include a structure and/or a component for separating the acoustic duct 502 and the space S2 in which the third portion 233 is positioned in order to reduce the interference between the sound waves transmitted along the acoustic duct 502 and the third portion 233. For example, the electronic device 101 may include a plate 540 for separating the first duct 502a of the acoustic duct 502 and the space S2 in which the third portion 233 is positioned.

FIG. 6A is a cross-sectional view of an electronic device, cut along line D-D′ of FIG. 5B according to an embodiment of the disclosure. FIG. 6B is a perspective view of a portion of a first frame part according to an embodiment of the disclosure. FIG. 6C is a front view of a first surface of a first frame part according to an embodiment of the disclosure.

Referring to FIG. 6A, according to an embodiment of the disclosure, an electronic device 101 may include a plate 540 for separating an acoustic duct 502 and a space S2 in which a third portion 233 is positioned. For example, the plate 540 may be coupled to a first frame part 510 as a separate component from the first frame part 510. For example, the first frame part 510 and the plate 540 may be coupled after being manufactured separately. However, it is not limited thereto. For example, the plate 540 may also be integrally formed with the first frame part 510. For example, the plate 540 and the first frame part 510 may also be integrally manufactured in a single process.

For example, at least a portion of a speaker 530 may be disposed in a frame 501. For example, the speaker 530 may include a diaphragm configured to generate sound waves by vibrating based on an electrical signal. The sound waves generated from the diaphragm may be emitted into a space S1 in a front of the speaker 530. The front may be understood as a direction in which the sound waves are substantially emitted from the speaker 530. The space S1 in the front of the speaker 530 may be referred to as an internal space of the first frame part 510 surrounding the front of the speaker 530 disposed in the first frame part 510. A space at a rear of the speaker 530 may provide a resonance space for resonance of the sound waves. The sound waves generated from the speaker 530 may be transmitted to an audio hole 521 along the acoustic duct 502, and may be provided to the outside of the frame 501 through the audio hole 521.

For example, the acoustic duct 502 may provide a path for the sound waves generated from the speaker 530 by connecting the space S1 in the front of the speaker 530 and the audio hole 521. As a portion of the acoustic duct 502 is formed inside the first frame part 510, the acoustic duct 502 may at least partially overlap the space in which the third portion 233 is disposed. In a case that the acoustic duct 502 and the space in which the third portion 233 is disposed are not separated and connected to each other, a quality of an audio signal provided from the speaker 530 may be deteriorated, and the third portion 233 may be damaged by a foreign substance and/or air introduced through the acoustic duct 502. The plate 540 may reduce deterioration of a quality of the audio signal and damage to the third portion 233 by separating the space S2 in which the third portion 233 is positioned from the acoustic duct 502.

For example, a first portion 231 and/or a second portion 232 may be supported by the first frame part 510. For example, the first frame part 510 may include a recess 511 in which a display 230 may be seated. For example, the recess 511 may be formed on a second surface 510b of the first frame part 510 supporting at least a portion of the display 230. For example, the recess 511 may be formed as a portion of the second surface 510b is recessed in a direction (e.g., a −z direction) facing the inside of the first frame part 510. A periphery of the recess 511 may be spaced apart from a periphery of the first frame part 510. The recess 511 may be formed in an internal side of the periphery of the first frame part 510. A sidewall (or a stepped portion) 512 may be formed by the recess 511. A portion of the third portion 233 may be supported by the first frame part 510 by contacting the recess 511. Since the third portion 233 extends from the first portion 231 disposed in the recess 511, it may face the sidewall 512 of the first frame part 510 formed in the recess 511.

According to an embodiment of the disclosure, the plate 540 may be disposed between the acoustic duct 502 and the space S2 in which the third portion 233 is positioned to separate the acoustic duct 502 and the space in which the third portion 233 is positioned. For example, a portion of the plate 540 may be supported by the first frame part 510 and positioned under the first portion 231 and the second portion 232 of the display 230 (e.g., in a −z axis direction). Another portion of the plate 540 may be positioned between a space (e.g., a space between the sidewall 512 and the third portion 233) in which a second frame part 520 is positioned. The other portion of the plate 540 may contact the sidewall 512. The plate 540 may separate the space S2 in which the third portion 233 is positioned and the acoustic duct 502, by being disposed between the space S2 in which the third portion 233 is positioned and the acoustic duct 502. For example, the space S2 in which the third portion 233 is positioned may be surrounded by the first frame part 510, the second frame part 520, and the plate 540.

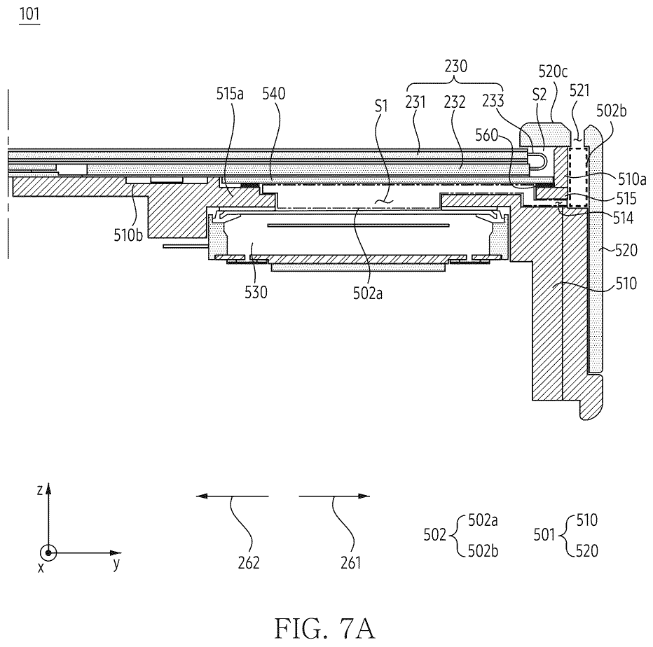

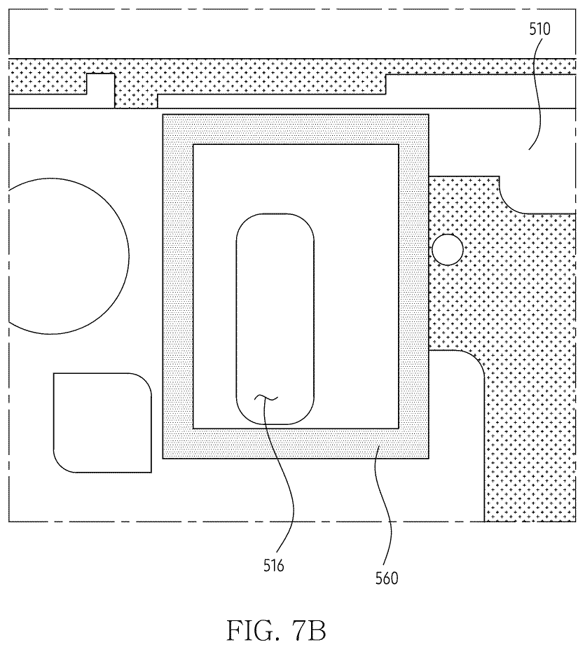

According to an embodiment of the disclosure, a through hole (e.g., an opening 516 of FIG. 7B) may be formed between the acoustic duct 502 and the space in which the third portion 233 is disposed. The acoustic duct 502 and the space in which the third portion 233 is positioned may be connected by the opening 516. The plate 540 may be included in the first frame part 510 by being integrally formed with the first frame part 510. The plate 540 may not be added as a separate component, and the opening 516 may not be formed in the first frame part 510. In a case that the opening 516 is not formed, the acoustic duct 502 and the space S2 in which the third portion 233 is positioned may be separated by a structure of the first frame part 510 itself. In a case that the plate 540 and the first frame part 510 are integrally formed, a thickness of approximately 0.3 mm to approximately 0.5 mm may be increased for mold strength. On the contrary, in a case that, in the first frame part 510, the opening 516 is formed and the plate 540 covering the opening 516 is disposed, an increase in a thickness of the first frame part 510 may be reduced. For example, a thickness of the plate 540 may be approximately 0.1 mm to approximately 0.15 mm, and by covering the opening 516 with the plate 540 having the thickness, the acoustic duct 502 and the space S2 in which the third portion 233 is positioned may be separated. In a case of forming the opening 516 and covering the opening 516 with the plate 540, an increase in the thickness of the first frame part 510 may be reduced compared to a case of separating the acoustic duct 502 and the space S2 in which the third portion 233 is positioned by omitting the opening 516.

According to an embodiment of the disclosure, the acoustic duct 502 may connect the space S1 in the front of the speaker 530 and the audio hole 521. For example, the acoustic duct 502 may include a first duct (or a first duct portion) 502a and a second duct (or a second duct portion) 502b. In an embodiment of the disclosure, the first duct 502a may be referred to as a portion of the acoustic duct 502 including a space surrounded by a dotted line. For example, in an embodiment of the disclosure, the second duct 502b may be referred to as a portion of the acoustic duct 502 including a space surrounded by a dash-dot line.

According to an embodiment of the disclosure, the first duct 502a may be a portion of the acoustic duct 502 formed inside the first frame part 510. For example, the first duct 502a may include the space S1 in the front of the speaker. For example, the first duct 502a may be connected to a through hole 514 passing through a first surface 510a from the inside of the first frame part 510 in which the speaker 530 is disposed. For example, the first duct 502a may extend from the space S1 in the front of the speaker 530 to the through hole 514. The first duct 502a formed inside the first frame part 510 may overlap the space S2 in which the third portion 233 is positioned. The plate 540 may be disposed between the first duct 502a and the space S2 in which the third portion 233 is positioned.

For example, the second duct 502b may be another portion of the acoustic duct 502 formed outside the first frame part 510 and connected to the audio hole 521. For example, the second duct 502b may be connected to the audio hole 521 and may be connected to the through hole 514 in a second direction 262. For example, the second duct 502b may be formed as a portion of the first surface 510a of the first frame part 510 facing a first direction 261 is recessed in the second direction 262.

Referring to FIGS. 6B and 6C, the first frame part 510 may include the first surface 510a and the second surface 510b. The first surface 510a may be a surface of the first frame part 510 facing the first direction 261. The second surface 510b may be a surface of the first frame part 510 supporting the at least a portion of the display 230. As described above, the recess 511 in which the display 230 may be seated may be formed on the second surface 510b.

For example, the first frame part 510 may include a recessed portion 513 for forming the second duct (e.g., the second duct 502b of FIG. 6A). The recessed portion 513 may be formed on the first surface 510a. For example, the recessed portion 513 may be formed as a portion of the first surface 510a is recessed in the second direction 262. The first surface 510a may be stepped by the recessed portion 513. When the second frame part (e.g., the second frame part 520 of FIG. 6A) is coupled to the first frame part 510, the recessed portion 513 may form a space between the first frame part 510 and the second frame part 520. The recessed portion 513 may be connected to the through hole 514 connected to the first duct 502a and the audio hole (e.g., the audio hole 521 of FIG. 6A) of the second frame part 520.

Referring back to FIG. 6A, the second duct 502b may be formed by the recessed portion (e.g., the recessed portion 513 of FIG. 6B). For example, the second duct 502b may be connected to the audio hole 521 and the through hole 514. The audio hole 521 may be formed on a surface 520c of the second frame part 520 substantially facing a front of the electronic device 101 to be connected to the space between the first frame part 510 and the second frame part 520 formed by the recessed portion 513. For example, the surface 520c of the second frame part 520 may be a surface of the second frame part 520 that is formed in a second portion (520b of FIG. 5A or 5B) and faces a +z direction. For example, the first duct 502a may be connected to the through hole 514 in the first direction 261, and the second duct 502b may be connected to the through hole 514 in the second direction 262. The first duct 502a and the second duct 502b may be connected to each other through the through hole 514. Since the second duct 502b is connected to the audio hole 521, the first duct 502a connected to the space S1 in the front of the speaker 530 may be connected to the audio hole 521.

According to an embodiment of the disclosure, the acoustic duct 502 may be separated from the space S2 in which the third portion 233 is positioned by the plate 540. For example, the space S2 in which the third portion 233 is positioned may be referred to as a space between the sidewall 512 formed by the recess 511 and the first portion 231. As the plate 540 separates the acoustic duct 502 from the space S2 in which the third portion 233 is positioned, interference between the sound waves transmitted along the acoustic duct 502 and the third portion 233 may be reduced. For example, when the sound waves, which are vibration of air, are transmitted to the audio hole 521 along the acoustic duct 502, the plate 540 may reduce the vibration of the sound waves from being transmitted to the third portion 233. As transmission of the sound waves to the third portion 233 is reduced, vibration of the third portion 233 due to the sound waves may be reduced. Since the vibration of the third portion 233 is reduced, noise due to the vibration of the third portion 233 may be reduced. As the noise is reduced by the plate 540, a quality of the audio signal provided from the speaker 530 may be improved. For example, in a case that a foreign substance and/or high-pressure air are introduced through the audio hole 521, the plate 540 may reduce an inflow of the foreign substance and/or the air into the space S2 in which the third portion 233 is positioned. As the inflow of the foreign substance and/or the air into the space S2 in which the third portion 233 is positioned is reduced, damage to the third portion 233 by the foreign substance and/or the air may be reduced.

In the above-described descriptions, the sidewall 512 has been described as a portion of the first frame part 510, but is not limited thereto. For example, the sidewall 512 may also be a portion of the second frame part 520. For example, the sidewall 512 may also be implemented in a form extending from the surface 520c of the second frame part 520. For example, in a case that the sidewall 512 is implemented as the portion of the second frame part 520, the second duct 502b may be implemented as a through hole extending from the audio hole 521.

FIG. 7A is a cross-sectional view of an electronic device cut along line D-D′ of FIG. 5B according to an embodiment of the disclosure. FIG. 7B illustrates a frame in which a sealing member is disposed according to an embodiment of the disclosure.

Referring to FIGS. 7A and 7B, according to an embodiment of the disclosure, an electronic device 101 may include a sealing member 560 (e.g., sealant). For example, the sealing member 560 may seal between a space S2 in which a third portion 233 is positioned and an acoustic duct 502.

For example, a first frame part 510 may include a seating portion 515 for supporting a plate 540. For example, the seating portion 515 may be referred to as a portion of the first frame part 510 contacted with a portion of the plate 540. For example, a portion of the seating portion 515 may extend from a sidewall 512 to the inside of the first frame part 510. Another portion 515a of the seating portion 515 may be a portion extending from a second surface 510b of the first frame part 510. However, it is not limited thereto. As a portion of the plate 540 is disposed on the seating portion 515, the plate 540 may be supported.

For example, the sealing member 560 may seal the acoustic duct 502 and the space S2 in which the third portion 233 is positioned, by being disposed between the seating portion 515 and the portion of the plate 540 disposed on the seating portion 515. Referring to FIG. 7B, the sealing member 560 may be disposed along at least a portion of the seating portion 515 contacted with the portion of the plate 540. For example, the sealing member 560 may be disposed along at least a portion of a periphery of the plate 540. For example, the sealing member 560 may be disposed to surround a periphery of an opening 516. The sealing member 560 illustrated in FIG. 7B may have an approximately quadrangular ring shape by being disposed along the periphery of the plate 540 having the approximately quadrangular ring shape, but is not limited thereto. For example, the sealing member 560 may also be disposed along a portion of the periphery of the plate 540.

For example, the sealing member 560 may include a compressible material. For example, the sealing member 560 may include poron, rubber, silicone, urethane, and/or a combination thereof. For example, the sealing member 560 may firmly seal a gap between the seating portion 515 and the plate 540 by being compressed by the plate 540. As the gap between the plate 540 and the seating portion 515 are sealed, the acoustic duct 502 may be separated from the space S2 in which the third portion 233 is positioned.

FIG. 8 is a cross-sectional view of an electronic device, cut along line D-D′ of FIG. 5B according to an embodiment of the disclosure.

In the above-described second housing part (e.g., the second housing part 220 of FIG. 5A), a first frame part (e.g., the first frame part 510 of FIG. 6A) and a second frame part (e.g., the second frame part 520 of FIG. 6A) have been described separately, but is not limited thereto. Referring to FIG. 8, the first frame part 510 and the second frame part 520 described above may be integrally formed. For example, the second frame part 520 may be referred to as a portion of a frame 501 integrally formed with the first frame part 510 other than a separate component coupled to the first frame part 510. Other components may be the same as components of an electronic device 101 described above, except that the frame 501 does not include a plurality of structures capable of coupling and has a single structure.

For example, at least a portion of a speaker 530 may be disposed inside the frame 501. An acoustic duct 502 may be formed inside the frame 501. The acoustic duct 502 may provide a path through which sound waves generated from the speaker 530 are transmitted to the outside of the electronic device 101 by connecting a space S1 in a front of the speaker 530 and an audio hole 521.

For example, the frame 501 may include the audio hole 521. The audio hole 521 may be formed on a surface 501a of the frame 501 facing substantially a front of the electronic device 101. For example, the surface 501a of the frame 501 may be a surface of the frame 501 facing a +z direction.

For example, the acoustic duct 502 may include a first duct 502a and a second duct 502b. For example, the first duct 502a may include the space S1 in the front of the speaker 530. For example, the first duct 502a may extend in a first direction 261 from the inside of the frame 501. For example, the second duct 502b may extend from the audio hole 521 in a direction (e.g., a −z direction) perpendicular to the first direction 261. For example, the direction in which the second duct 502b extends may be a direction facing the inside of the frame 501. For example, the first duct 502a and the second duct 502b may be connected through a through hole 514. For example, the through hole 514 may be formed between the first duct 502a and the second duct 502b. For example, the first duct 502a may be connected to the through hole 514 in the first direction 261, and the second duct 502b may be connected to the through hole 514 in a second direction 262.

As illustrated in FIG. 8, since the first frame part 510 and the second frame part 520 are integrally formed, a separate member (e.g., the second frame part 520) for covering a third portion 233 may be omitted. The frame 501 may cover the third portion 233 so that the third portion 233 is not exposed to the outside of the electronic device 101. For example, the third portion 233 may be covered by the frame 501. The frame 501 in which the first frame part 510 and the second frame part 520 are integrally formed may stably protect the third portion 233. Since the first frame part 510 and the second frame part 520 are integrally formed, a manufacturing process of the frame 501 may be simplified.

As described above, the electronic device 101 may include a plate 540 for separating the first duct 502a of the acoustic duct 502 and a space S2 in which the third portion 233 is positioned. The plate 540 may reduce interference between sound waves transmitted along the acoustic duct 502 and the third portion 233 by separating the acoustic duct 502 from the space S2 in which the third portion 233 is positioned.

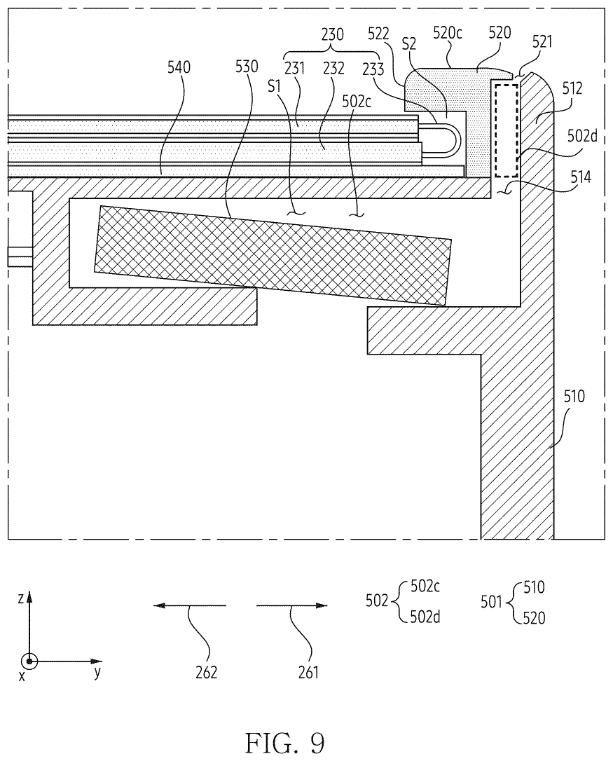

FIG. 9 is a cross-sectional view of an electronic device cut along line D-D′ of FIG. 5B according to an embodiment of the disclosure.

Referring to FIG. 9, a first frame part 510 may support a display 230. For example, a first portion 231 and a second portion 232 may be supported by the first frame part 510.

According to an embodiment of the disclosure, a second frame part 520 may be disposed in the first frame part 510. The second frame part 520 may have a structure for covering the third portion 233. For example, the second frame part 520 may include a flange portion 522 protruding to cover the third portion 233. As the flange portion 522 covers the third portion 233, the third portion 233 may be protected by the second frame part 520.

According to an embodiment of the disclosure, an acoustic duct 502 may include a first duct 502c and a second duct 502d. For example, the second frame part 520 may be disposed to be spaced apart from a sidewall 512 of the first frame part 510. For example, a gap may be formed between the second frame part 520 and the sidewall 512. For example, the first duct 502c may be formed by a gap between the first frame part 510 and the second frame part 520. An audio hole 521 may be formed at an end portion of the gap connected to the outside of the frame 501.

According to an embodiment of the disclosure, the first frame part 510 may include a through hole 514. For example, the first duct 502c may be connected to the through hole 514. For example, the through hole 514 may be formed in a direction (e.g., a direction parallel to a z-axis) perpendicular to a first direction 261 and a second direction 262, and the first duct 502c may be connected to the through hole 514 in a direction (e.g., a −z direction) substantially facing a rear of the electronic device 101. The through hole 514 may be connected to a space S1 in a front of a speaker 530. The second duct 502d may be connected to the space S1 in the front of the speaker 530 and the through hole 514. For example, the second duct 502d may be connected to the through hole 514 in a direction (e.g., +z direction) substantially facing a front of the electronic device 101. According to an embodiment of the disclosure, a path through which sound waves are transmitted may be formed along the first duct 502c, the through hole 514, the second duct 502d, and the audio hole 521. Since a portion of the acoustic duct 502 is formed in the direction substantially facing the front of the electronic device 101, the speaker 530 may be positioned obliquely to at least a portion of the first frame part 510 so that the sound waves emitted to the front of the speaker 530 may be smoothly transmitted along the acoustic duct 502. For example, the front of the speaker 530 may not be disposed parallel to the display 230 but may be inclined toward the acoustic duct 502.

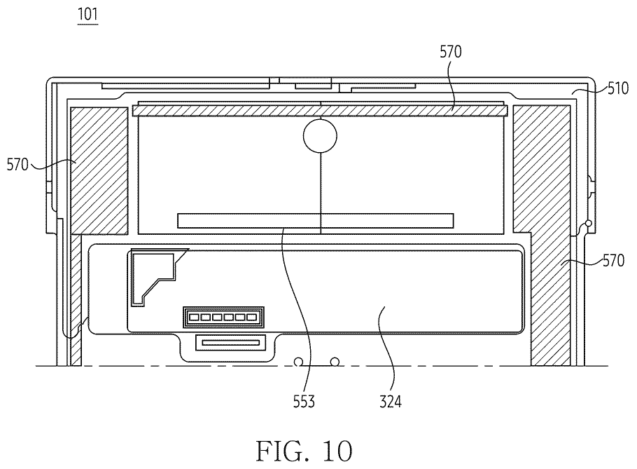

FIG. 10 illustrates a frame from which a display is omitted according to an embodiment of the disclosure.

Referring to FIG. 10, according to an embodiment of the disclosure, an electronic device 101 may include an adhesive tape 570 disposed on a first frame part 510 supporting a first portion (e.g., the first portion 231 of FIG. 6A) and/or a second portion (e.g., the second portion 232 of FIG. 6A). For example, the adhesive tape 570 may be disposed between a first portion 231 of a display 230 and the first frame part 510. For example, referring to the display module (e.g., the display module 550 of FIG. 5C) illustrated in FIG. 5C, the adhesive tape 570 may be attached under a protective tape (e.g., the protective tape 590 of FIG. 5C) (e.g., in a −z direction).

For example, the adhesive tape 570 may couple the first frame part 510 and the first portion 231. For example, a surface of the adhesive tape 570 may be coupled to the first frame part 510, and another surface of the adhesive tape 570 opposite to the surface may be coupled to the first portion 231 of the display 230. The adhesive tape 570 may be provided in plural to couple a plurality of areas of the first portion 231 contacted with the first frame part 510 to the first frame part 510.

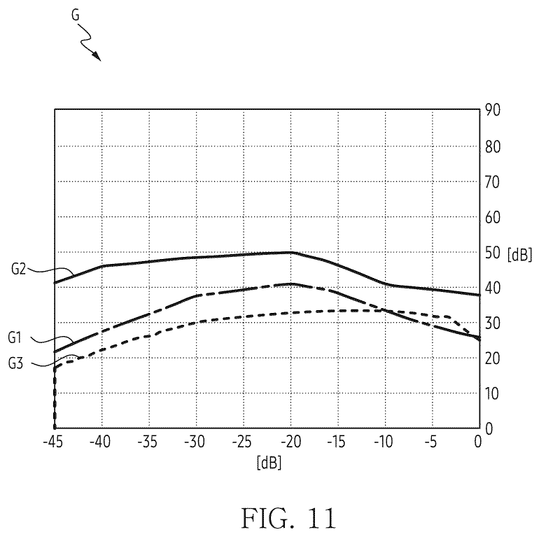

FIG. 11 is a graph for comparing a quality of an audio signal provided by an electronic device according to a comparative example and an audio signal provided by an electronic device according to an embodiment of the disclosure.

For example, an electronic device (e.g., the electronic device 101 of FIG. 6A) may be used for a voice call. The electronic device 101 may receive a wireless signal including an audio signal through an antenna, and the audio signal included in the received wireless signal may be provided to a user through a speaker (e.g., the speaker 530 of FIG. 6A). For example, the speaker 530 may include a receiver. The audio signal provided from the speaker 530 may be transmitted to the user through an acoustic duct (e.g., the acoustic duct 502 of FIG. 6A).

In a graph G of FIG. 11, an x-axis is a gain (unit: decibel) of an inputted audio signal, and a y-axis is distortion (unit: decibel) of an audio signal provided from the speaker.

A first graph G1 of FIG. 11 is a graph of an audio signal provided from a speaker of the electronic device according to a comparative example when the audio signal of approximately 1020 Hz is inputted. A second graph G2 of FIG. 11 is a graph of an audio signal provided from the speaker 530 of the electronic device 101 according to an embodiment when the audio signal of approximately 1020 Hz is inputted. A third graph G3 of FIG. 11 is a graph indicating a lower limit of an international standard for a voice call quality defined in 3GPP.

For example, the electronic device 101 according to an embodiment may be referred to as the electronic device 101 illustrated in FIG. 6A. The electronic device 101 according to an embodiment may include a structure in which a space (e.g., the space S2 of FIG. 6A) in which a second portion (e.g., the third portion 233 of FIG. 6A) is positioned and the acoustic duct 502 are separated.

For example, the electronic device according to a comparative example may include a structure in which a space in which a portion corresponding to the third portion 233 of the electronic device 101 according to an embodiment is positioned and an acoustic duct are connected.

Referring back to FIG. 11, the second graph G2 may have a size higher than that of the first graph G1 within a gain range of an audio signal between approximately 0 dB and approximately −45 dB. The first graph G1 may have a size lower than that of the third graph G3 within a gain range of an audio signal between approximately 0 dB and approximately −10 dB. For example, the electronic device 101 according to an embodiment may not meet the lower limit of the international standard for the voice call quality when providing an audio signal for an audio signal of a size between approximately 0 dB and approximately −10 dB. The values indicated in the first graph G1 and the second graph G2 in FIG. 11 may be confirmed by the following Table 1.

TABLE 1

| First graph (G1) | | | Second graph (G2) | | |
|---|---|---|---|---|---|
| | Distortion | Noise ratio | Gain | Distortion | Noise ratio |
| Gain(dB) | (dB) | (%) | (dB) | (dB) | (%) |
| 0.0 | 25.65 | 5.22 | 0.0 | 38.48 | 1.19 |
| −3.0 | 27.53 | 4.20 | −3.0 | 39.05 | 1.12 |
| −10.0 | 33.09 | 2.21 | −10.0 | 41.30 | 0.86 |
| −20 | 41.29 | 1.13 | −20 | 50.29 | 0.31 |
| −30 | 37.88 | 1.28 | −30 | 48.79 | 0.36 |
| −40 | 27.92 | 4.02 | −40 | 46.13 | 0.49 |

Referring to Table 1, a quality of an audio signal provided from the electronic device according to a comparative example may be lower than a quality of an audio signal provided from the electronic device 101 according to an embodiment. The audio signal provided from the electronic device according to a comparative example may include more noise components than the audio signal provided from the electronic device 101 according to an embodiment. For example, in the electronic device according to a comparative example, when sound waves generated from the speaker are transmitted to an audio hole along the acoustic duct, vibration may be caused in the portion corresponding to the third portion 233 of the electronic device 101 according to an embodiment by vibration of the sound waves, and thus noise may be generated, and a quality of the audio signal may be deteriorated by the generated noise. In the electronic device 101 according to an embodiment of the disclosure, since the acoustic duct 502 and the space S2 in which the third portion 233 is positioned may be separated, vibration of the third portion 233 may be reduced. As the vibration of the third portion 233 is reduced, the quality of the audio signal provided from the electronic device 101 according to an embodiment may be improved.

An electronic device 101 is provided. The electronic device 101 may comprise a frame 501 including a first frame part 510, and a second frame part 520, coupled to the first frame part 510, including an audio hole 521. The electronic device 101 may comprise a display 230. The display 230 may include a first portion 231 contacted with a display panel including a plurality of pixels, a second portion 232, opposite to the first portion 231, connected to display driver integrated circuitry 553 configured to control the display panel, and a third portion 233, connecting the first portion 231 and the second portion 232. The third portion 233 may protrude from the first portion 231 toward a first direction 261. The third portion 233 may be covered by the second frame part 520. The electronic device 101 may comprise a speaker 530 disposed in the frame 501. The electronic device 101 may comprise an acoustic duct 502 passing through at least a portion of the frame 501 to connect a space S1 in a front of the speaker 530 and the audio hole 521. The acoustic duct 502 may be separated from a space S2 in which the third portion 233 is positioned by at least a portion of the first frame part 510.

According to an embodiment of the disclosure, the acoustic duct 502 may include a first duct 502a, and a second duct 502b. The first duct 502a may include the space S1 in a front of the speaker 530. The first duct 502a may be connected to a through hole 514 passing through the at least the portion of the frame 501 in the first direction 261. The second duct 502b may be connected to the audio hole 521. The second duct 502b may be connected to the through hole 514 in a second direction 262 opposite to the first direction 261.

According to an embodiment of the disclosure, the audio hole 521 may be substantially formed on a surface 501a of the frame 501 substantially facing a front of the electronic device 101.

According to an embodiment of the disclosure, the first frame part 510 may include a plate 540. The plate 540 may further include the plate 540 separating the space S2 in which the third portion 233 is positioned and a first duct 502a of the acoustic duct 502, by being at least partially disposed between the space S2 in which the third portion 233 is positioned and the acoustic duct 502.

According to an embodiment of the disclosure, the third portion 233 may be positioned in the space S2 formed by the first frame part 510, the second frame part 520, and the plate 540.

According to an embodiment of the disclosure, the first frame part 510 may include a seating portion 515 supporting the plate 540 by being contacted with a portion of the plate 540. The electronic device 101 may further comprise a sealing member 560. The sealing member 560 may seal between the space S2 in which the third portion 233 is positioned and the acoustic duct 502 by being disposed between the portion of the plate 540 and at least a portion of the seating portion 515.

According to an embodiment of the disclosure, the first frame part 510 may include a recess 511 supporting the first portion 231. The second frame part 520 may be disposed in the recess 511 to be spaced apart from a sidewall 512 of the first frame part 510 formed by the recess 511. The acoustic duct 502 may include a first duct 502c, and a second duct 502d. The first duct 502c may be formed by a gap between the first frame part 510 and the second frame part 520. The first duct 502c may be connected to the through hole 514 of the first frame part 510. The second duct 502d may be connected to the space S1 in a front of the speaker 530 and the through hole 514.

According to an embodiment of the disclosure, the second frame part 520 may include a flange portion 522 covering the third portion 233 by overlapping the third portion 233.

According to an embodiment of the disclosure, the electronic device may further comprise a housing 201. The housing 201 may include a first housing part 210, and a second housing part 220. The second housing part 220 may be movably coupled to the first housing part 210 in the first direction 261 and a second direction 262 opposite to the first direction 261. The frame 501 may be a portion of the second housing part 220.

According to an embodiment of the disclosure, a portion of the first portion 231 may be rollable into the first housing part 210 based on a movement of the second housing part 220.

According to an embodiment of the disclosure, the third portion 233 may be covered by the frame 501 independently of the movement of the second housing part 220.

According to an embodiment of the disclosure, the electronic device 101 may further comprise an adhesive tape 570. The adhesive tape 570 may be disposed between the first portion 231 and the first frame part 510. The adhesive tape 570 may couple the first portion 231 to the first frame part 510.

According to an embodiment of the disclosure, the third portion 233 may be at least partially curved to connect the first portion 231 and the second portion 232.

According to an embodiment of the disclosure, the electronic device 101 may further comprise a printed circuit board 324 electrically connected to the display driver integrated circuitry 553. The printed circuit board 324 may be disposed between the second portion 232 and the first frame part 510.

According to an embodiment of the disclosure, the display 230 may be electrically connected to the printed circuit board 324 through the third portion 233.

An electronic device 101 is provided. The electronic device 101 may comprise a housing 201, a display 230, a speaker 530, an acoustic duct 502, and a plate 540. The housing 201 may include a first housing part 210, and a second housing part 220. The second housing part 220 may be movably coupled to the first housing part 210 in the first direction 261 and a second direction 262 opposite to the first direction 261. The second housing part 220 may include an audio hole 521. The display 230 may include a first portion 231 or the second portion 232, and a third portion 233. The first portion 231 or the second portion 232 may be supported by the second housing part 220. The second portion 232 may protrude from the first portion 231 toward the first direction 261. The second portion 232 may be covered by the second housing part 220. The speaker 530 may be disposed in the second housing part 220. The acoustic duct 502 may connect a space S1 in a front of the speaker 530 and the audio hole 521. The plate 540 may be at least partially disposed between the acoustic duct 502 and the space S2 in which the second portion 232 is positioned to separate the acoustic duct 502 and the space S2 in which the second portion 232 is positioned.

According to an embodiment of the disclosure, the second housing part 220 may include the first frame part 510 and the second frame part 520. The first frame part 510 may support the first portion 231. The second frame part 520 may be coupled to the first frame part 510. The second frame part 520 may cover the second portion 232. The second frame part 520 may include an audio hole 521.

According to an embodiment of the disclosure, the acoustic duct 502 may include a first duct 502a and a second duct 502b. The first duct 502a may include the space S1 in a front of the speaker 530. The first duct 502a may be connected to a through hole 514 passing through, in the first direction 261, at least a portion of the second housing part 220. The second duct 502b may be connected to the audio hole 521. The second duct 502b may be connected to the through hole 514 in the second direction 262 opposite to the first direction 261.

According to an embodiment of the disclosure, the second housing part 220 may include a seating portion 515 supporting the plate 540 by being contacted with a portion of the plate 540. The electronic device 101 may further comprise a sealing member 560. The sealing member 560 may seal between the space in which the second portion 232 is positioned and the acoustic duct 502, by being disposed between the portion of the plate 540 and at least a portion of the seating portion 515.

According to an embodiment of the disclosure, the second housing part 220 may include the first frame part 510 and the second frame part 520. The first frame part 510 may include a recess 511 supporting the first portion 231. The second frame part 520 may be disposed in the recess 511 to be spaced apart from a sidewall 512 of the first frame part 510 formed by the recess 511. The acoustic duct 502 may include a first duct 502c and a second duct 502d. The first duct 502c may be formed by a gap between the first frame part 510 and the second frame part 520. The first duct 502c may be connected to the through hole 514 of the first frame part 510. The second duct 502d may be connected to the space S1 in a front of the speaker 530 and the through hole 514.

An electronic device is provided. The electronic device comprises a housing including a first housing part, and a second housing part movably coupled to the first housing part in a first direction and a second direction opposite to the first direction, the second housing defining an audio hole, a flexible display including a first portion, a second portion, opposite to the first portion of the display, electrically connected to display driver integrated circuitry configured to control the display, and a third portion, extending from the first portion of the display to the second portion of the display, at least partially curved, wherein the third portion of the display is covered by the second housing part, a speaker disposed in the second housing part, wherein the second housing part defines an acoustic duct for connecting a space in front of the speaker and the audio hole, and a plate disposed between a portion of the second housing part defining the acoustic duct and the display to separate the acoustic duct and a space in which the third portion of the display is positioned.

According to an embodiment of the disclosure, the second housing part includes a first frame part supporting the first portion of the display, and a second frame part, coupled to the first frame part, covering the third portion of the display, defining the audio hole.

According to an embodiment of the disclosure, the audio duct includes a first duct portion, at least partially positioned in front of the speaker, and a second duct portion, connected to the first duct portion by a through hole of the second housing part, connected to the audio hole.

According to an embodiment of the disclosure, the second housing part includes a seating portion supporting the plate. The electronic device comprises a sealing member disposed between the plate and the seating portion to seal a gap between the audio duct and the space in which the third portion is positioned.

According to an embodiment of the disclosure, the audio hole is defined at a front side of the second housing part.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
a frame including:
a first frame part, and
a second frame part, coupled to the first frame part, defining an audio hole;
a display including:
a first portion contacted with a display panel including a plurality of pixels,
a second portion, opposite to the first portion, connected to display driver integrated circuitry configured to control the display panel, and
a third portion, connecting the first portion and the second portion, protruding from the first portion toward a first direction, covered by the second frame part;
a speaker disposed in the frame; and
an acoustic duct passing through at least a portion of the frame to connect a space in a front of the speaker inside the frame and the audio hole,
wherein the acoustic duct is separated from a space in which the third portion is positioned by at least a portion of the first frame part.

2. The electronic device of claim 1, wherein the acoustic duct includes:
a first duct portion, including the space in a front of the speaker, connected to a through hole passing through the at least the portion of the frame in the first direction; and
a second duct portion, connected to the audio hole, connected to the through hole in a second direction opposite to the first direction.

3. The electronic device of claim 1, wherein the audio hole is formed on a surface of the frame facing a front side of the electronic device.

4. The electronic device of claim 1,
wherein the first frame part includes a plate, and
wherein the plate separates the space in which the third portion is positioned and a first duct portion of the acoustic duct, by being at least partially disposed between the space in which the third portion is positioned and the acoustic duct.

5. The electronic device of claim 4, wherein the third portion is positioned in a space formed by the first frame part, the second frame part, and the plate.

6. The electronic device of claim 4,
wherein the first frame part includes a seating portion supporting the plate by being contacted with a portion of the plate, and
wherein the electronic device further comprises a sealing member sealing between the space in which the third portion is positioned and the acoustic duct by being disposed between the portion of the plate and at least a portion of the seating portion.

7. The electronic device of claim 1,
wherein the first frame part includes a recess supporting the second portion,
wherein the second frame part is disposed in the recess to be spaced apart from a sidewall of the first frame part formed by the recess, and
wherein the acoustic duct includes:
a first duct portion formed by a gap between the first frame part and the second frame part and connected to the through hole of the first frame part, and
a second duct portion connected to the space in a front of the speaker and the through hole.

8. The electronic device of claim 1, wherein the second frame part includes a flange portion covering the third portion by overlapping the third portion.

9. The electronic device of claim 1, further comprising:
a housing including:
a first housing part, and
a second housing part movably coupled to the first housing part in the first direction and a second direction opposite to the first direction,
wherein the frame is a portion of the second housing part.

10. The electronic device of claim 9, wherein a portion of the first portion is configured to be rollable into the first housing part based on a movement of the second housing part.

11. The electronic device of claim 9, wherein the third portion is covered by the frame independently of a movement of the second housing part.

12. The electronic device of claim 1, further comprising:
an adhesive tape, disposed between the third portion and the first frame part, coupling the third portion to the first frame part.

13. The electronic device of claim 1, wherein the third portion is at least partially curved to connect the first portion and the second portion.

14. The electronic device of claim 1, further comprising:
a printed circuit board (PCB) electrically connected to the display driver integrated circuitry (DDI),
wherein the PCB is disposed between the second portion and the first frame part.

15. The electronic device of claim 14, wherein the display is electrically connected to the PCB through the second portion.

16. An electronic device comprising:
a housing including:
a first housing part, and
a second housing part movably coupled to the first housing part in a first direction and a second direction opposite to the first direction, the second housing defining an audio hole;
a flexible display including:
a first portion,
a second portion, opposite to the first portion of the display, electrically connected to display driver integrated circuitry configured to control the display, and
a third portion, extending from the first portion of the display to the second portion of the display, at least partially curved, wherein the third portion of the display is covered by the second housing part;
a speaker disposed in the second housing part, wherein the second housing part defines an acoustic duct for connecting a space in front of the speaker and the audio hole; and
a plate disposed between a portion of the second housing part defining the acoustic duct and the display to separate the acoustic duct and a space in which the third portion of the display is positioned.

17. The electronic device of claim 16, wherein the second housing part includes:
a first frame part supporting the first portion of the display, and
a second frame part, coupled to the first frame part, covering the third portion of the display, defining the audio hole.

18. The electronic device of claim 17, wherein the audio duct includes:
a first duct portion, at least partially positioned in front of the speaker, and
a second duct portion, connected to the first duct portion by a through hole of the second housing part, connected to the audio hole.

19. The electronic device of claim 16,
wherein the second housing part includes a seating portion supporting the plate, and
wherein the electronic device further comprises a sealing member disposed between the plate and the seating portion to seal a gap between the audio duct and the space in which the third portion is positioned.

20. The electronic device of claim 16, wherein the audio hole is defined at a front side of the second housing part.
